(19) United States
(12) Patent Application Publication
(10) Pub. No.: US 2002/0105539 A1
(43) Pub. Date: Aug. 8, 2002

(54) Apparatus and methods for displaying information on mobile communication devices

(75) Inventors: Reuven Gamzon, Moshav Bet-Oved (IL); Eli Arlazoroff, Tel Aviv (IL); Dror Daniel Ziv, Tel Aviv (IL)

Correspondence Address: WEINGARTEN, SCHURGIN, GAGNEBIN & LEBOVICI LLP, TEN POST OFFICE SQUARE, BOSTON, MA, 02109, US

(73) Assignee: WAPDWAP (ISRAEL) LTD.

(21) Appl. No.: 09/954,484

(22) Filed: Sep. 17, 2001

Related U.S. Application Data
(60) Provisional application No. 60/233,136, filed on Sep. 18, 2000.

(51) Int. Cl. G09G 5/00; G06F 15/16

(52) U.S. Cl. 345/738; 345/864; 709/204; 709/218; 345/744; 345/747

(57) ABSTRACT

A system and methodology for providing content to a user via a mobile communicator having limited display capabilities, the methodology including enabling a user to select content of interest at at least one web site via a device other than said mobile communicator, automatically providing a link from said content of interest to mobile communicator-configured content, and displaying at least said mobile communicator-configured content on said mobile communicator.

### REFERENCE TO COMPUTER PROGRAM LISTING APPENDIX

Computer program listing appendices are submitted herewith on one compact disc and one duplicate compact disc. The total number of compact discs including duplicates is two. The files on the compact disc are software executable code (appendix A) for carrying out the preferred embodiment of the invention.

Their names, dates of creation, directory locations, and sizes in bytes are:

Directory apndx-A containing file MPREST.HEX (Appendix A) of Aug. 27, 2001 and of length 24,173,716 bytes.

The files are referred to herein as appendix A. The material on the compact discs is incorporated by reference herein.

### FIELD OF THE INVENTION

The present invention relates to apparatus and methods for displaying information on mobile communication devices.

### BACKGROUND OF THE INVENTION

Use of mobile communication devices to obtain access to information networks is well known. A suitable protocol for this purpose is WAP (wireless application protocol).

Providing virtual links between virtual locations in an information network is also well known. Oracle9iAS Wireless, previously known as Portal2Go, is a wireless Web application server which is claimed to create wireless applications that may be personalized by their end users. Filtering services are provided for simple automatic filtering and translation of existing Internet content. A personalization portal is provided which lets users select which wireless services they want to see on their mobile device's start page.

Yodlee.com, Inc. has described an e-personalization system delivered over the web or on hand-held and mobile devices, which gives PDA and wireless phone customers a real-time view of their personal account information, in the palm of their hand. A consolidated, summarized view of a user's personal account information is offered, from over 2000 sites across the Web. It is claimed that the Yodlee2Go system does not merely reformat general Website content for viewing in a mini-browser on a PDA or web-enabled telephone. Instead, it uniquely delivers a user's own personal account information.

Octopus Personal Edition is a system which accesses multiple web sources in a single view. Any view can be created using a drag and drop interface. Users can customize the information their own way by editing and creating their own views.

The disclosures of all publications mentioned in the specification and of the publications cited therein are hereby incorporated by reference.

### SUMMARY OF THE INVENTION

The present invention seeks to provide improved apparatus and methods for displaying information on mobile communication devices.

There is thus provided, in accordance with a preferred embodiment of the present invention, a service that links Web content to new emerging mobile services. Mobile phone users can easily personalize and consolidate information from any web site right into their phone, using an intuitive drag & drop function on their PC. The selected topics become links that generate traffic to mobile portals, services and transactions. Personalized phone pages consolidate frequently viewed information from any sources thus dramatically reducing the number of phone ‘clicks’. User experience is greatly improved and usage of the mobile Internet service is increased. The service typically comprises two simple stages:

a) Setting up a personal page by dragging and dropping pieces of data from any Web pages (or any other source) into an emulated handset on the PC screen.

b) Using the wireless handset to receive the consolidated information on one single page with one single ‘click’.

The system preferably is operative to pinpoint out of any web or information page the most elementary user selected fraction such as a specific sentence, word, cell in a table or even a single letter or symbol. The system typically performs the pinpointing function by tracking and extracts user-defined topics form dynamic Web pages.

Unlike wireless services that initially display menus and links, vital information of users of the present invention is displayed first. After reviewing the updated information on the personal phone page, clicking on any information quote automatically leads to a corresponding wireless website or service. For example: clicking on a specific stock quote on the personal phone page will lead to a designated wireless service that will allow buying and selling that stock. Clicking on a current auction quote will lead to a relevant wireless auction site.

The system shown and described herein preferably provides On the Fly links. By dragging & dropping a topic from a Web page, the system shown and described herein can preferably create a new link to a mobile page or service. This new link can be created in a few different ways. For example, the content provider can embed the link in the HTML code, which is not another web link but a link to the new mobile media (such as WML pages). Links can also be created by using artificial intelligence to estimate relevant links. These links can automatically be assigned to the information topic dragged by the user or can be displayed to the user on a pop-up menu or other from so the user can immediately select the relevant link.

There is thus provided, in accordance with a preferred embodiment of the present invention, a methodology for providing content to a user via a mobile communicator having limited display capabilities, the methodology including enabling a user to access a web site via a device other than the mobile communicator, enabling a user to view content on the web site, and enabling a user to select content of interest to the user forming at least part of the content, wherein a user selection takes place while the user views at least part of the content of interest.

Further in accordance with a preferred embodiment of the present invention, the user selection takes place while the user views at least part of the content of interest in the format that it normally appears on the web site.

Still further in accordance with a preferred embodiment of the present invention, the user selection may be effected by at least one mouse click on at least a portion of the content of interest.

Additionally in accordance with a preferred embodiment of the present invention, the user selection may be effected by at least one mouse click on an icon located adjacent at least a portion of the content of interest.

Still further in accordance with a preferred embodiment of the present invention, the user selection may be effected by dragging and dropping at least a portion of the content of interest.

Further in accordance with a preferred embodiment of the present invention, the user selection may be effected by dragging and dropping an icon located adjacent at least a portion of the content of interest.

Still further in accordance with a preferred embodiment of the present invention, the user selection may be effected by at least one mouse click on at least a portion of the content of interest.

Further in accordance with a preferred embodiment of the present invention, the user selection may be effected by at least one mouse click on an icon located adjacent at least a portion of the content of interest.

Still further in accordance with a preferred embodiment of the present invention, the user selection may be effected by dragging and dropping at least a portion of the content of interest.

Additionally in accordance with a preferred embodiment of the present invention, the user selection may be effected by dragging and dropping an icon located adjacent at least a portion of the content of interest.

Further in accordance with a preferred embodiment of the present invention, the user selection includes user selection of multiple items of interest to be provided for display on the mobile communicator, and the mobile communicator is operative for displaying at least a plurality of the multiple items of interest for simultaneous viewing thereon.

Still further in accordance with a preferred embodiment of the present invention, the multiple items of interest originate from multiple web sites.

Additionally in accordance with a preferred embodiment of the present invention, the multiple web sites are not necessarily linked.

Additionally in accordance with a preferred embodiment of the present invention, the methodology also includes automatically providing a link from the content of interest to mobile communicator-configured content, and displaying at least the mobile communicator-configured content on the mobile communicator.

Further in accordance with a preferred embodiment of the present invention, the mobile communicator-configured content includes at least part of the content of interest selected by the user.

Still further in accordance with a preferred embodiment of the present invention, the mobile communicator-configured content includes at least part of the content of interest selected by the user and also includes other content related thereto.

Further in accordance with a preferred embodiment of the present invention, the mobile communicator-configured content includes at least part of the content of interest selected by the user as well as other content related thereto which was not viewed by the user on the device other than the mobile communicator.

Still further in accordance with a preferred embodiment of the present invention, the methodology also includes enabling the user to select the content of interest to the user on the at least one web site for display to the user on the mobile communicator in the form of at least one page appearing in a mobile communicator-configured format, and in response to a user request to receive the at least one page, downloading at least part of the content of interest from the at least one web site generally in real time.

Further in accordance with a preferred embodiment of the present invention, the at least one page includes only a single page.

Still further in accordance with a preferred embodiment of the present invention, the methodology also includes automatically updating the at least one page to include therein content of interest which was not available generally in real time.

Also provided, in accordance with another preferred embodiment of the present invention, is methodology for providing content to a user via a mobile communicator having limited display capabilities, the methodology including enabling a user to access at least one web site via a device other than the mobile communicator, enabling a user to select multiple items of interest to be provided for display on the mobile communicator, and displaying at least a plurality of the multiple items of interest for simultaneous viewing on the mobile communicator.

Further in accordance with a preferred embodiment of the present invention, the multiple items of interest originate from multiple web sites which multiple web sites are not necessarily linked.

Still further in accordance with a preferred embodiment of the present invention, the methodology also includes automatically providing a link from at least one of the multiple items of interest to mobile communicator-configured content, and displaying at least the mobile communicator-configured content on the mobile communicator.

Further in accordance with a preferred embodiment of the present invention, the mobile communicator-configured content includes at least part of the at least one of the multiple items of interest selected by the user.

Still further in accordance with a preferred embodiment of the present invention, the mobile communicator-configured content includes at least part of the at least one of the multiple items of interest selected by the user and also includes other content related thereto.

Additionally in accordance with a preferred embodiment of the present invention, the mobile communicator-configured content includes at least part of the at least one of the multiple items of interest selected by the user as well as other content related thereto which was not viewed by the user on the device other than the mobile communicator.

Also in accordance with a preferred embodiment of the present invention, the methodology includes enabling the user to select the content of interest to the user on the at least one web site for display to the user on the mobile communicator in the form of at least one page appearing in a mobile communicator-configured format, and, in response to a user request to receive the at least one page, downloading at least part of the content of interest from the at least one web site generally in real time.

Further in accordance with a preferred embodiment of the present invention, the at least one page includes only a single page.

Still further in accordance with a preferred embodiment of the present invention, the methodology also includes automatically updating the at least one page to include therein content of interest which was not available generally in real time.

Also provided, in accordance with another preferred embodiment of the present invention, is a methodology for providing content to a user via a mobile communicator having limited display capabilities, the methodology including enabling a user to select content of interest at at least one web site via a device other than the mobile communicator, automatically providing a link from the content of interest to mobile communicator-configured content, and displaying at least the mobile communicator-configured content on the mobile communicator.

Further in accordance with a preferred embodiment of the present invention, the mobile communicator-configured content includes at least part of the content of interest selected by the user.

Still further in accordance with a preferred embodiment of the present invention, the mobile communicator-configured content includes at least part of the content of interest selected by the user and also includes other content related thereto.

Further in accordance with a preferred embodiment of the present invention, the mobile communicator-configured content includes at least part of the content of interest selected by the user as well as other content related thereto which was not viewed by the user on the device other than the mobile communicator.

Further in accordance with a preferred embodiment of the present invention, the methodology also includes enabling the user to select the content of interest to the user on the at least one web site for display to the user on the mobile communicator in the form of at least one page appearing in a mobile communicator-configured format, and in response to a user request to receive the at least one page, downloading at least part of the content of interest from the at least one web site generally in real time.

Still further in accordance with a preferred embodiment of the present invention, the at least one page includes a single page.

Additionally in accordance with a preferred embodiment of the present invention, the methodology also includes automatically updating the at least one page to include therein content of interest which was not available generally in real time.

Also provided, in accordance with a preferred embodiment of the present invention, is methodology for providing content to a user via a mobile communicator having limited display capabilities, the methodology including enabling a user to select content of interest to the user on at least one web site for display to the user on the mobile communicator in the form of at least one page appearing in a mobile communicator-configured format, and in response to a user request to receive the at least one page, downloading at least part of the content of interest from the at least one web site generally in real time.

Further in accordance with a preferred embodiment of the present invention, the at least one page includes only a single page.

Still further in accordance with a preferred embodiment of the present invention, the methodology also includes automatically updating the at least one page to include therein content of interest which was not available generally in real time.

Also provided, in accordance with another preferred embodiment of the present invention, is a methodology for providing content to a user via a mobile communicator having limited display capabilities, the methodology including enabling a user to select content of interest to the user on a mark up language rendered page viewable to the user, wherein the user is enabled to specify selected content to a resolution finer than that defined by tags of the mark up language.

Still further in accordance with a preferred embodiment of the present invention, the user is enabled to select the content of interest when viewing the mark up language rendered page on a screen of a mobile communicator.

Additionally in accordance with a preferred embodiment of the present invention, the user is enabled to select the content of interest when viewing the mark up language rendered page other than on a screen of a mobile communicator.

Also provided, in accordance with another preferred embodiment of the present invention, is a methodology for providing content to a user via a mobile communicator having limited display capabilities, the methodology including enabling a user to select content of interest to the user on a mark up language rendered page viewable to the user, wherein the user is enabled to specify selected content to a user selected resolution and the content specifically selectable by the user to a user selected resolution includes at least some content which is designated by tags to at least the user-selected resolution, and at least some content which is designated by tags to a resolution coarser than the user-selected resolution.

Further provided, in accordance with another preferred embodiment of the present invention, is a methodology for providing content to a user via a mobile communicator having limited display capabilities, the methodology including providing at least one user interface server, receiving and storing at least one user preference at the at least one user interface server, collecting information from a plurality of web servers at least partially in accordance with the at least one user preference, and supplying at least part of the information to the at least one mobile communicator.

Still further in accordance with a preferred embodiment of the present invention, the at least one user preference is received from a computer rather than from a mobile communicator.

Further in accordance with a preferred embodiment of the present invention, the at least one user preference is received from a mobile communicator.

Still further in accordance with a preferred embodiment of the present invention, the methodology also includes receiving, at the at least one user interface server, at least one request from at least one mobile communicator, and wherein the at least one user interface server is operative for collecting the information responsive to the at least one request.

Further in accordance with a preferred embodiment of the present invention, the at least one user preference is received by the at least one user interface server at a time substantially earlier than the time at which the at least one user interface server receives the at least one request and supplies the at lest part of the information to the at least one mobile communicator.

Still further in accordance with a preferred embodiment of the present invention, the computer provides personal user preferences of multiple users.

Also provided, in accordance with a preferred embodiment of the present invention, is a methodology for providing content to a user via a mobile communicator having limited display capabilities, the methodology including enabling a user to select content of interest to the user on a mark up language rendered page viewable to the user, wherein at least in certain instances when the user selects the content of interest, mobile communicator specific data linked to the content of interest is made available for use by the mobile communicator.

Further in accordance with a preferred embodiment of the present invention, the data includes at least one of an address of at least one mobile communicator formatted page, a function that enables retrieval of information from a web server, and at least part of information required for executing a commercial transaction.

Still further in accordance with a preferred embodiment of the present invention, the at least part of information required for executing a commercial transaction includes a function that enables retrieval of client information by the web server.

Still further in accordance with a preferred embodiment of the present invention, the data includes at least one of: an address of at least one mobile communicator formatted page, a function that enables retrieval of information from a web server, and at some client information.

Also provided, in accordance with another preferred embodiment of the present invention, is a methodology for providing dynamically changing information to a user including selecting by a user of dynamic content of interest while the user views the content of interest on a dynamically changing web site, automatically analyzing, in response to the user selecting the dynamic content of interest, the context of the content of interest on the web site, and thereafter automatically providing to the user substantially only the content of interest which was selected by the user, notwithstanding dynamic changes in the content of interest and notwithstanding at least some changes in the context in the dynamically changing website.

Further in accordance with a preferred embodiment of the present invention, automatically analyzing includes automatically designating a plurality of context parameters, and automatically providing includes searching for an at least similar context in the dynamically changing web site by employing the plurality of context parameters, identifying a plurality of candidate contexts by employing the plurality of context parameters, choosing from the at least one candidate contexts a most probable correct context, and providing to the user substantially only the dynamic content of interest within the most probable correct context.

Further in accordance with a preferred embodiment of the present invention, automatically designating the plurality of context parameters includes assigning original context weightings to the plurality of context parameters based at least on the uniqueness of each context parameter in the web site at the time the user selected the dynamic content of interest.

Still further in accordance with a preferred embodiment of the present invention, choosing includes assigning changed context weightings to the plurality of context parameters based at least on the uniqueness of each context parameter in the web site at the time the searching, identifying and choosing takes place.

Additionally in accordance with a preferred embodiment of the present invention, identifying employs the original context weightings.

Further in accordance with a preferred embodiment of the present invention, choosing employs the original context weightings and the changed context weightings.

Also provided, in accordance with another preferred embodiment of the present invention, is a methodology for providing content to a user via a communicator having limited display capabilities, the methodology including enabling a user to access a web site via a device other than the communicator, the device having display capabilities which exceed those of the communicator, enabling a user to view content on the web site, and enabling a user to select content of interest to the user forming at least part of the content, wherein a user selection takes place while the user views at least part of the content of interest.

Further provided, in accordance with another preferred embodiment of the present invention, is a system for providing content to a user via a mobile communicator having limited display capabilities, the system including a website access device enabling a user to access a web site via a device other than the mobile communicator, and a content viewing GUI enabling a user to view content on the web site and to select content of interest to the user forming at least part of the content, wherein the GUI is operative to receive a user selection while displaying at least part of the content of interest to the user.

Also provided, in accordance with another preferred embodiment of the present invention, is a system for providing content to a user via a mobile communicator having limited display capabilities, the system including a website access device enabling a user to access a web site via a device other than the mobile communicator, a selector enabling the user to select multiple items of interest to be provided for display on the mobile communicator, and a simultaneous viewer operative to display at least a plurality of the multiple items of interest for simultaneous viewing on the mobile communicator.

Further provided, in accordance with another preferred embodiment of the present invention, is a system for providing content to a user via a mobile communicator having limited display capabilities, the methodology including a website content selection device enabling a user to select content of interest at at least one web site via a device other than the mobile communicator, a link provider automatically providing a link from the content of interest to mobile communicator-configured content, and a content display generator operative to display at least the mobile communicator-configured content on the mobile communicator.

Also provided, in accordance with still another preferred embodiment of the present invention, is a system for providing content to a user via a mobile communicator having limited display capabilities, the system including a content selector enabling a user to select content of interest to the user on at least one web site for display to the user on the mobile communicator in the form of at least one page appearing in a mobile communicator-configured format, and a real time content downloader operative in response to a user request to receive the at least one page, to download at least part of the content of interest from the at least one web site generally in real time.

Also provided, in accordance with still another preferred embodiment of the present invention, is a system for providing content to a user via a mobile communicator having limited display capabilities, the system including a content selector enabling a user to select content of interest to the user on a mark up language rendered page viewable to the user, wherein the user is enabled to specify selected content to a resolution finer than that defined by tags of the mark up language.

Also provided, in accordance with still another preferred embodiment of the present invention, is a system for providing content to a user via a mobile communicator having limited display capabilities, the system including a content selector operative to enable a user to select content of interest to the user on a mark up language rendered page viewable to the user, wherein the user is enabled to specify selected content to a user selected resolution, and wherein the content specifically selectable by the user to a user selected resolution includes at least some content which is designated by tags to at least the user-selected resolution, and at least some content which is designated by tags to a resolution coarser than the user-selected resolution.

Also provided, in accordance with still another preferred embodiment of the present invention, is a system for providing content to a user via a mobile communicator having limited display capabilities, the system including enabling a user to select content of interest to the user on a mark up language rendered page viewable to the user, wherein at least in certain instances when the user selects the content of interest, mobile communicator specific data linked to the content of interest is made available for use by the mobile communicator.

Also provided, in accordance with still another preferred embodiment of the present invention, is a system for providing content to a user via a mobile communicator having limited display capabilities, the system including at least one user interface server receiving and storing at least one user preference, an information collector operative to collect information from a plurality of web servers at least partially in accordance with the at least one user preference, and an information communicator supplying at least part of the information to the at least one mobile communicator.

Also provided, in accordance with still another preferred embodiment of the present invention, is a system for providing dynamically changing information to a user including a content selector operative to receive from a user a selection of dynamic content of interest while displaying the content of interest to the user on a dynamically changing web site, a context analyzer operative, in response to the user selecting the dynamic content of interest, to automatically analyze the context of the content of interest on the web site, and a content provider operative, thereafter, to automatically provide to the user substantially only the content of interest which was selected by the user, notwithstanding dynamic changes in the content of interest and notwithstanding at least some changes in the context in the dynamically changing website.

The terms “large page” and “small page” are used herein to refer to different display modes which typically but not necessarily characterize fixed and mobile display devices respectively. An example of a mobile display device is a mobile communicator such as a cellular telephone. The term “fixed Internet” is used to refer to a reservoir of Internet sites suitable for display on large-page display devices. It is appreciated that such a reservoir may be suitable for access by devices which are not fixed. The term “mobile Internet” or “wireless Internet” is used to refer to a reservoir of Internet sites suitable for display on small-page display devices. It is appreciated that such a reservoir may be suitable for access by devices which are not wireless and not mobile, e.g. small fixed computer terminals.

According to a preferred embodiment of the present invention, a population of links is defined between two computer networks (such as but not limited to the fixed and mobile networks respectively). Typically, the links create a mapping of at least a portion of the content universe defined by one of the computer networks into or onto at least a portion of the content universe defined by the other of the computer networks.

### BRIEF DESCRIPTION OF THE DRAWINGS

The present invention will be understood and appreciated more fully from the following detailed description, taken in conjunction with the drawings in which:

FIGS. 1A-1C, taken together, form a pictorial illustration of functionality of a system and methodology for providing content to a user via a mobile communicator, the system and methodology being constructed and operative in accordance with a preferred embodiment of the present invention;

FIG. 2 is a pictorial illustration of additional functionality of a system and methodology for providing content to a user via a mobile communicator, the system and methodology being constructed and operative in accordance with a preferred embodiment of the present invention;

FIG. 3 is a pictorial illustration of functionality of a system and methodology for providing content to a user via a mobile communicator, the system and methodology being constructed and operative in accordance with another preferred embodiment of the present invention;

FIG. 4 is a pictorial illustration of functionality of a system and methodology for providing content to a user via a mobile communicator, the system and methodology being constructed and operative in accordance with yet another preferred embodiment of the present invention which provides links to mobile Internet pages;

FIG. 5 is a simplified top-level functional block diagram of a mobile communicator content consolidation system constructed and operative in conjunction with naive websites, accordance with a first preferred embodiment of the present invention;

FIGS. 6A-6E are diagrams of tables included in the user preference database 210 of FIG. 5. The user preference database may for example be based on Microsoft's SQLServer;

FIGS. 7A-7G, taken together, form a simplified flowchart illustration of the operations of user interface 135 (left column) and server software 200 (right column) in FIG. 1, in the course of a consolidated personal page definition session;

FIGS. 8A-8C, taken together, form a simplified flowchart illustration of a preferred content extraction and displaying method performed by the server software 200;

FIG. 9 is a simplified top-level functional block diagram of a mobile communicator content consolidation system constructed and operative in conjunction with cooperative websites in accordance with another preferred embodiment of the present invention;

FIG. 10 is a diagram of a table typically included in the user preference database 215 of FIG. 9 in addition to the tables of FIGS. 6A-6D;

FIGS. 11A-11E, taken together, form a simplified flowchart illustration of the operations of server software 205 in FIG. 9 (left column) in conjunction with (right column) a conventional browser 185 such as Microsoft Internet Explorer, in the course of a consolidated personal page definition session;

FIGS. 12A-12C, taken together, form a simplified flowchart illustration of a preferred content extraction and displaying method performed by the server software 205 responsive to a suitable request received from a mobile communicator device 190 serving a user 195 who has previously performed the content selection method of FIG. 11;

FIG. 13A is a simplified pictorial illustration of a naive large Internet page;

FIG. 13B is a simplified pictorial illustration of a enabled large Internet page which may be generated from the naive Internet page of FIG. 13A;

FIGS. 14-20 are simplified pictorial illustrations of screen displays generated by personal consolidation user interface 135 in FIG. 5 in the course of performing the method of FIGS. 7A-7G;

FIGS. 21-23 are simplified pictorial illustrations of screen displays generated by the mobile communicator 190 in FIG. 5 in the course of performing the method of FIGS. 8A-8C;

FIGS. 24-26 are simplified pictorial illustrations of screen displays generated by browser 185 in FIG. 9 in the course of performing the method of FIGS. 11A-11E;

FIG. 27A is a pictorial illustration of a marked fixed Internet page, comprising the conventional website page of FIG. 13A, on which has been marked an information item which is of interest to a user;

FIG. 27B is a pictorial illustration of the marked source code corresponding to FIG. 27A which typically is generated by the method of the present invention responsive to the user marking operation, as shown herein in FIG. 7D, step 410;

FIG. 27C is a diagram illustration of the output of an html parser which has parsed the marked page of FIGS. 27A-27B;

FIGS. 28A-28C, taken together, form a simplified flowchart illustration of a preferred method for performing step 480 of FIG. 7G;

FIGS. 29A-29B, taken together, form a simplified flowchart illustration of a preferred method for performing step 550 of FIG. 8B; and

FIG. 30 illustrates content extraction tags added to a network-posted page to delimit content that is to be displayed on a mobile device.

Attached herewith are the following appendices which aid in the understanding and appreciation of one preferred embodiment of the invention shown and described herein:

CD-ROM Appendix A is a computer listing of a preferred software implementation of a system and methodology for providing content to a user via a mobile communicator, constructed and operative in accordance with a preferred embodiment of the present invention.

### DETAILED DESCRIPTION OF PREFERRED EMBODIMENTS

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

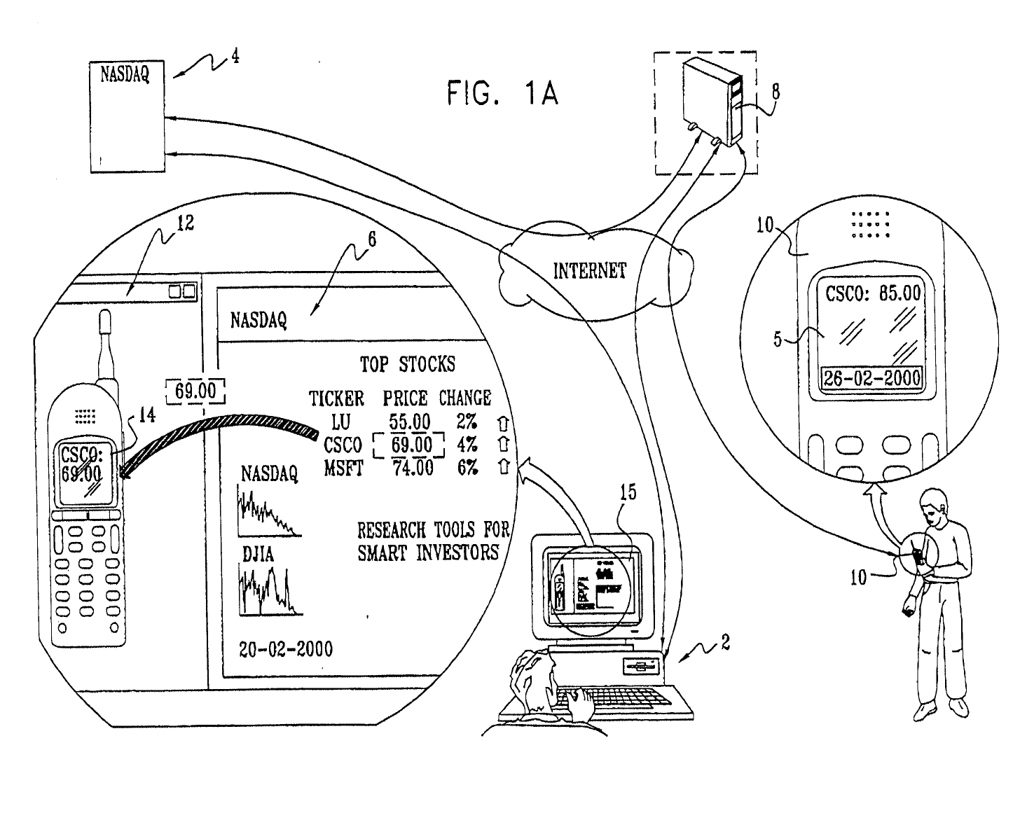

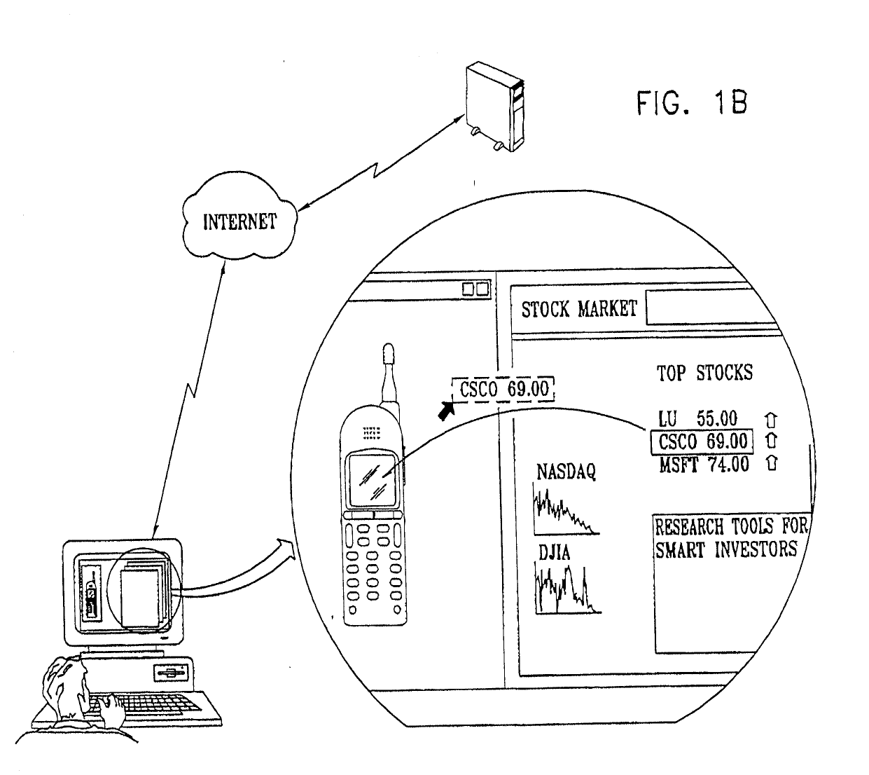

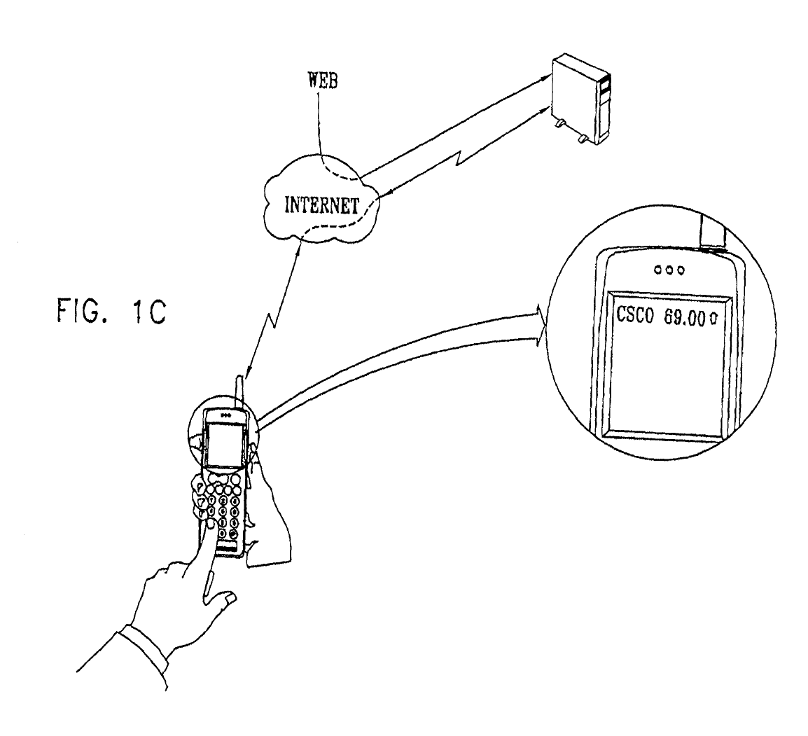

Reference is now made to FIGS. 1A-1C, which taken together form a pictorial illustration of functionality of a preferred embodiment of the present invention. As seen in FIG. 1A, there is provided a system and methodology for providing content to a user via a mobile communicator, such as a cellular telephone 100 having limited display capabilities.

As seen in FIG. 1A-1C, a user, preferably employing a conventional personal computer 2 accesses a web site 4, such as, for example, a NASDAQ web site which contains information which is of interest to the user. In accordance with a preferred embodiment of the present invention, the information of interest to the user, such as one or more stock prices, is updated at frequently intervals and may appear in the web site in different locations or formats at different times.

The present invention enables a user to select the precise information of interest to the user and to receive this information in its updated current form, at times or instances selected by the user via a mobile communicator, such as cellular telephone 10. Preferably, the selected information of interest appears on a display 5 of cellular telephone 10.

It is a particular feature of the invention that the user may designate “dynamic content” to a desired degree of precision, such as a stock price which undergoes continuous changes, and receives the updated dynamic content, previously designated by the user at future times.

It is a particular feature of the present invention that the precision or fineness of the selection of information that the user can make is generally without limit. Thus, the user need not select any information which he does not wish to see, even if that information is provided on the web site together with other information. It is thus appreciated that, in this way, the user can minimize clutter of his mobile communicator screen and thus optimize the amount of information which can be readily viewed on the screen.

It is a particular feature of a preferred embodiment of the present invention that the user may designate “dynamic content” to a desired degree of precision, such as a stock price which undergoes continuous changes, and receives the updated dynamic content, previously designated by the user at future times.

In the illustrated embodiment of FIG. 1 the user, employing personal computer 2, directly accesses the NASDAQ site 4, via the Internet. A NASDAQ web page, shown at reference numeral 6 at the right side of the screen of personal computer 2, is viewed by the user. Using designation software provided in accordance with the present invention, the user may designate selected information for display on the mobile communicator.

Such designation software is typically embodied in a browser plug-in which opens a pane in a browser window or an additional window. Alternatively, the software may be embodied in software resident at personal computer 2 which is separate from the browser software. Alternatively, the designation software does not reside on the personal computer 2 but rather resides on a web server 8, which may be accessed by personal computer 2 via the Internet.

Irrespective of where the designation software resides, the user is preferably provided with a user interface 12, typically having an appearance such as that seen at the left side of the screen of personal computer 2. Using this user interface, the user may readily “drop” a designated content item, such as the price of CISCO stock, selected by the user typically using conventional “drag and drop” functionality, onto a mobile communicator display location, such as an image 14 of a display of a cellular telephone, which may be identical to telephone 10 of the user.

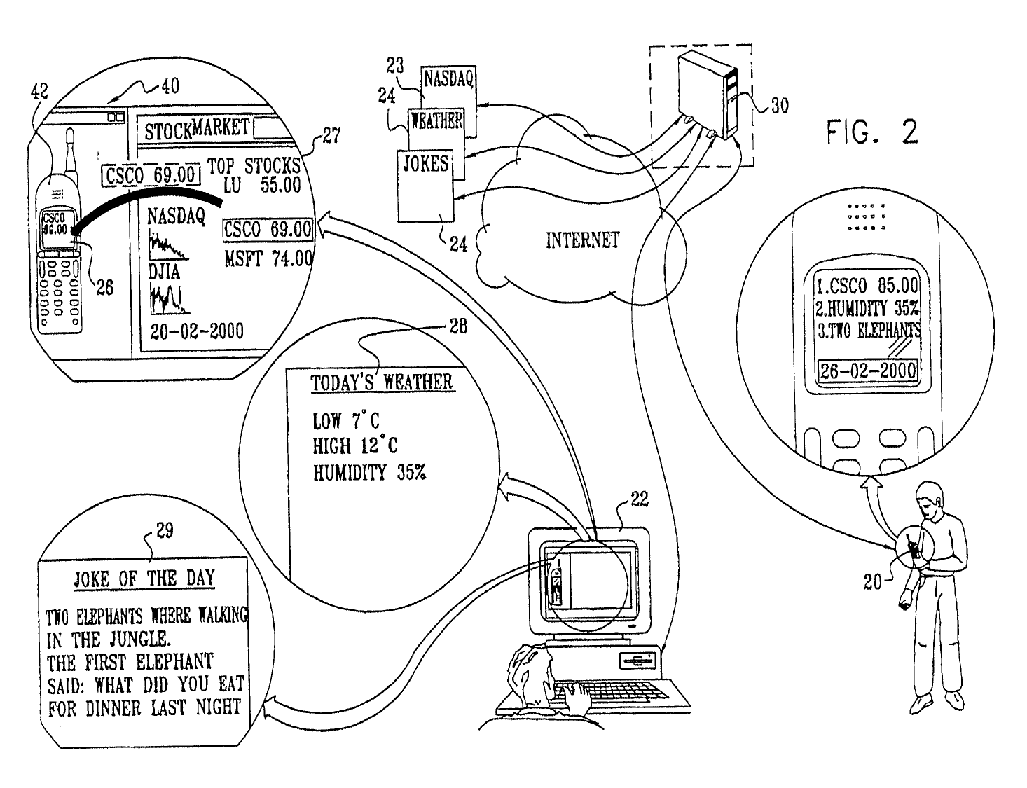

Reference is now made to FIG. 2, which is a pictorial illustration of additional functionality of a preferred embodiment of the present invention. The functionality of FIG. 2 is characterized in that it enables user selection of multiple items of interest to be provided for display on the mobile communicator and in that the mobile communicator is operative for displaying at least a plurality of the multiple items of interest for simultaneous viewing thereon.

As seen in FIG. 2, there is provided a system and methodology for providing content to a user via a mobile communicator, such as a cellular telephone 200 having limited display capabilities.

As seen in FIG. 2, a user, preferably employing a conventional personal computer 22 accesses multiple web sites, such as, for example, a NASDAQ web site 23, a weather web site 24 and a jokes web site 25, all of which contain information which is of interest to the user. In accordance with a preferred embodiment of the present invention, the information of interest to the user, such as one or more stock prices in the NASDAQ web site 23, the current weather in the weather web site 25 and the Joke of the Day in the jokes web site 25 is updated at frequently intervals and may appear in the web site in different locations or formats at different times.

The present invention enables a user to select the precise information of interest to the user and to receive this information in its updated current form, at times or instances selected by the user via a mobile communicator, such as cellular telephone 20. Preferably, the selected information of interest appears on a display 26 of cellular telephone 20.

It is a particular feature of the invention that the user may designate multiple items of “dynamic content” on one or more web sites, to a desired degree of precision, and receives the updated dynamic content, previously designated by the user, at future times notwithstanding dynamic changes in that content.

As noted above, it is a particular feature of a preferred embodiment of the present invention that the precision or fineness of the selection of information that the user can make is generally without limit. Thus, the user need not select any information which he does not wish to see, even if that information is provided on the web site together with other information. It is thus appreciated that, in this way, the user can minimize clutter of his mobile communicator screen and thus optimize the amount of information which can be readily viewed on the screen, and enjoy simultaneous viewing of multiple disparate items of dynamic content on a screen of limited size.

It is thus a particular feature of a preferred embodiment of the present invention that the user may designate multiple elements of “dynamic content” to a desired degree of precision, such as a stock price which undergoes continuous changes, and simultaneously view multiple elements of the updated dynamic content, previously designated by the user, at future times.

In the illustrated embodiment of FIG. 2 the user, employing personal computer 22, directly accesses the NASDAQ site 23, the weather site 24 and the jokes site 25 via the Internet. Typically a NASDAQ web page, shown at reference numeral 27 at the right side of the screen of personal computer 22, is viewed by the user. Using designation software provided in accordance with the present invention, the user may designate selected information for display on the mobile communicator.

Typically thereafter, a weather web page, shown at reference numeral 28 at the right side of the screen of personal computer 22, is viewed by the user. Using designation software provided in accordance with the present invention, the user may designate selected weather information for display on the mobile communicator.

At any other time, typically a jokes web page, shown at reference numeral 29 at the right side of the screen of personal computer 22, is viewed by the user. Using designation software provided in accordance with the present invention, the user may designate a selected category of joke, such as the “Joke of the Day” for display on the mobile communicator.

Such designation software is typically embodied in a browser plug-in which opens a pane in a browser window or an additional window. Alternatively, the software may be embodied in software resident at personal computer 22 which is separate from the browser software. Alternatively, the designation software does not reside on the personal computer 22 but rather resides on a web server 30, which may be accessed by personal computer 22 via the Internet.

Irrespective of where the designation software resides, the user is preferably provided with a user interface 40, typically having an appearance such as that seen at the left side of the screen of personal computer 22. Using this user interface, the user may readily “drop” a designated content item, such as the price of CISCO stock, selected by the user typically using conventional “drag and drop” functionality, onto a mobile communicator display location, such as an image 42 of a display of a cellular telephone, which may be identical to telephone 20 of the user.

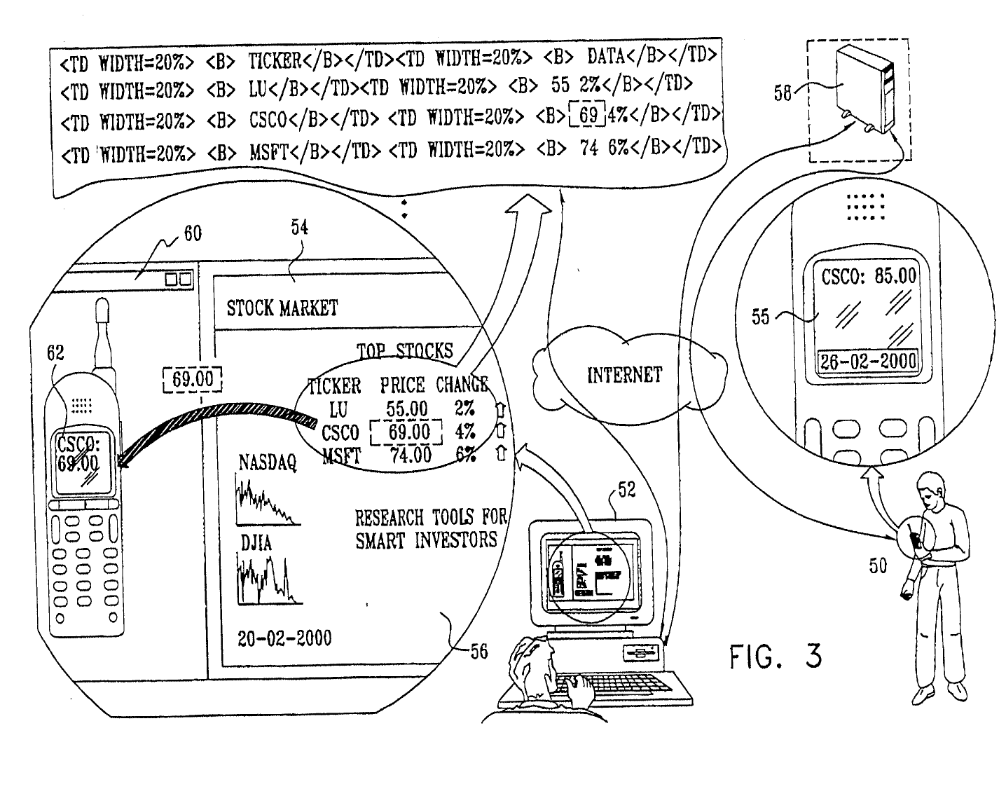

Reference is now made to FIG. 3, which is a pictorial illustration of functionality of a preferred embodiment of the present invention. As seen in FIG. 1 and FIG. 2 there is provided a system and methodology for providing content to a user via a mobile communicator, such as a cellular telephone 50 having limited display capabilities.

As seen in FIG. 3, a user, preferably employing a conventional personal computer 52 accesses a web site 54, such as, for example, a NASDAQ web site which contains information which is of interest to the user. In accordance with a preferred embodiment of the present invention, the information of interest to the user, such as one or more stock prices, is updated at frequently intervals and may appear in the web site in different locations or formats at different times.

FIG. 3 is provided to illustrate the particular functionality of the present invention, whereby a user is enabled to select the precise information of interest to the user and to receive this information in its updated current form, at times or instances selected by the user via a mobile communicator, such as cellular telephone 50. Preferably, the selected information of interest appears on a display 55 of cellular telephone 50.

As noted above, it is a particular feature of the invention that the user may designate “dynamic content” to a desired degree of precision, such as a stock price which undergoes continuous changes, and receives the updated dynamic content, previously designated by the user at future times.

FIG. 3 shows that a given item of content, here the CISCO stock price forms only part of a body of data delimited by adjacent tags. In this case, the tag preceding such data is <B> and the tag following such data is <B\>. It is thus seen that between these two tags appears the following information: 69 4%

It is a particular feature of the present invention that any part of the total dynamic data appearing between two such tags may be selected. In this case only the “69” is selected and the 4% is not selected.

More generally, it is a particular feature of the present invention that any desired part of any dynamic data structure may be selected in this way. For example, any one or more cells containing dynamic data in a table may be selected and any part of the dynamic data in any one or more cells may be selected.

It is thus appreciated that the precision or fineness of the selection of dynamic information that the user can make is generally without limit. Thus, the user need not select any information which he does not wish to see, even if that information is provided on the web site together with other information. It is thus appreciated that, in this way, the user can minimize clutter of his mobile communicator screen and thus optimize the amount of dynamic information which can be readily viewed on the screen.

It is thus a particular feature of a preferred embodiment of the present invention that the user may designate “dynamic content” to a desired degree of precision, such as a stock price which undergoes continuous changes, and receives the updated dynamic content, previously designated by the user at future times.

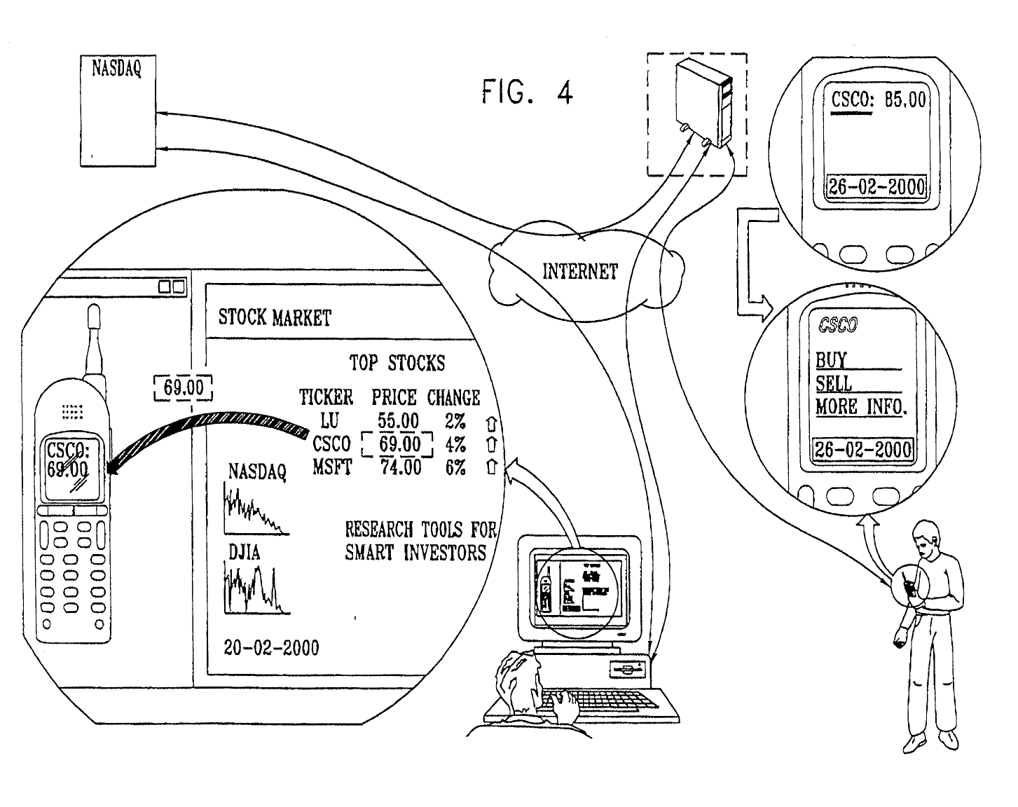

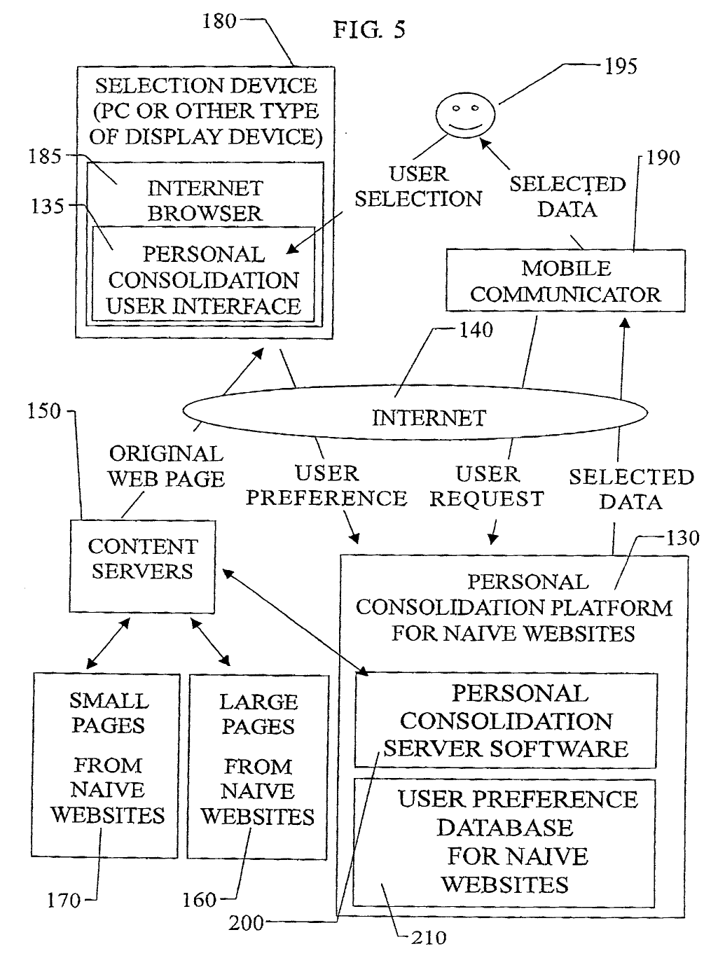

FIG. 4 illustrates an automatic link feature provided in accordance with a preferred embodiment of the present invention. Bubble 70 illustrates a large page screen display presented to the user in the course of a session with personal consolidation user interface 135 described in detail below with reference to FIG. 5. Bubble 72 illustrates a small page screen display presented to the user as a result of the user's having elected to include the price of CSCO in his consolidated mobile communicator page. As indicated by the underscoring of CSCO in bubble 72, the CSCO price on the consolidated small page of bubble 72 is provided as a link to another small page, shown in bubble 74, which includes further presentations, including transaction-enabling presentations, pertaining to CSCO.

FIG. 5 is a simplified top-level functional block diagram of a mobile communicator content consolidation system constructed and operative in conjunction with naive websites, accordance with a first preferred embodiment of the present invention. As shown, the system includes a personal consolidation platform computer 130 and a personal consolidation user interface 135. The system of FIG. 5 is operative in conjunction with an information network 140 such as the Internet. The network 140 is associated with content servers 150 which typically have reservoirs of information 160 and 170 respectively suitable for display on display devices with a relatively large display area and information for display on display devices with a relatively small display area.

The reservoir of information 160 typically serves personal computers 180 via Internet browsers 185 within which the interface 135 typically resides, and other computers having a relatively large display. Reservoir 160 typically supports html-type languages. The reservoir of information 170 typically serves mobile telephones and other mobile communicators 190 with relatively limited display capabilities and typically supports limited mark-up language protocol, including wml and chtml and not including html-type languages or including only certain formats of html-type languages which formats are particularly suited to limited display capacity devices.

The personal consolidation platform computer 130 of FIG. 5 typically comprises personal consolidation server software 200 and user preference database 210.

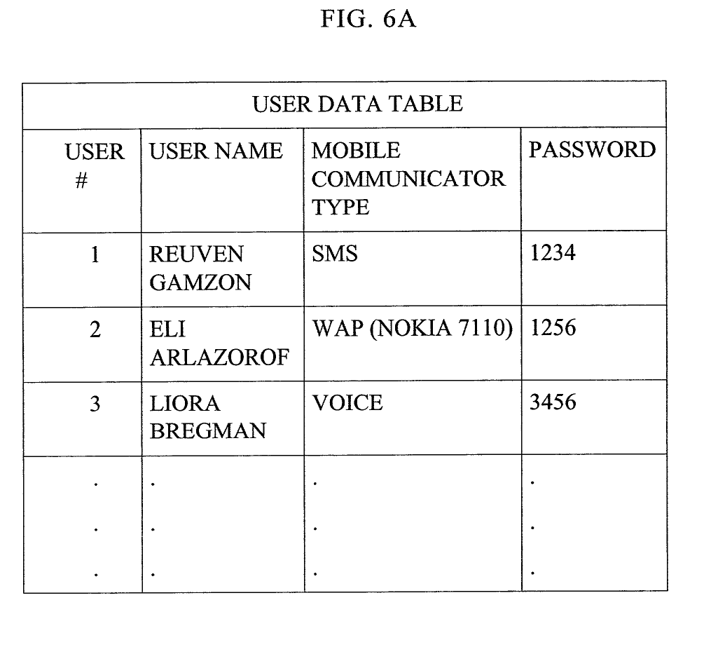

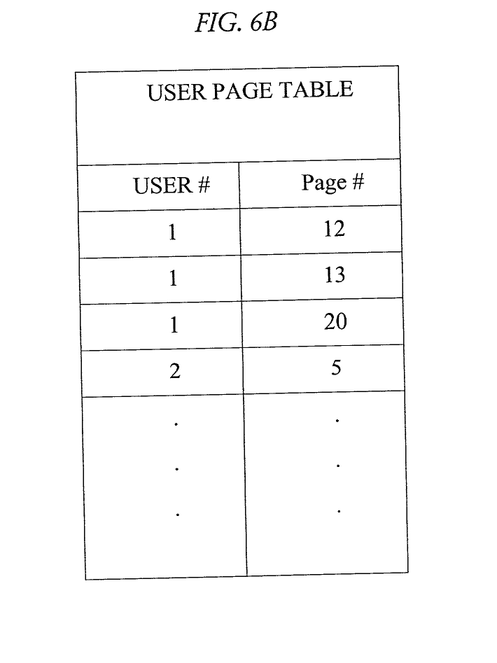

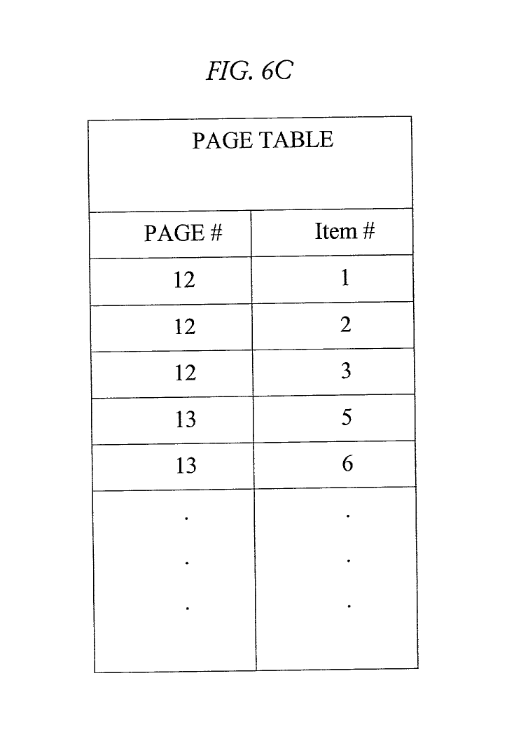

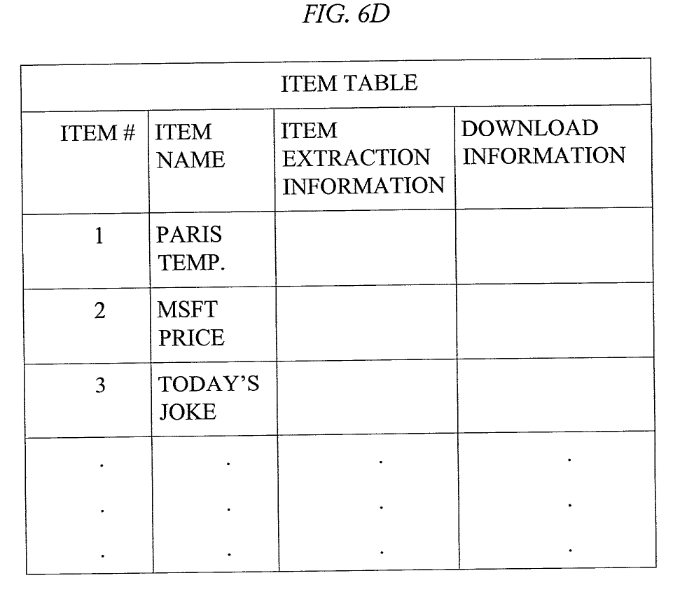

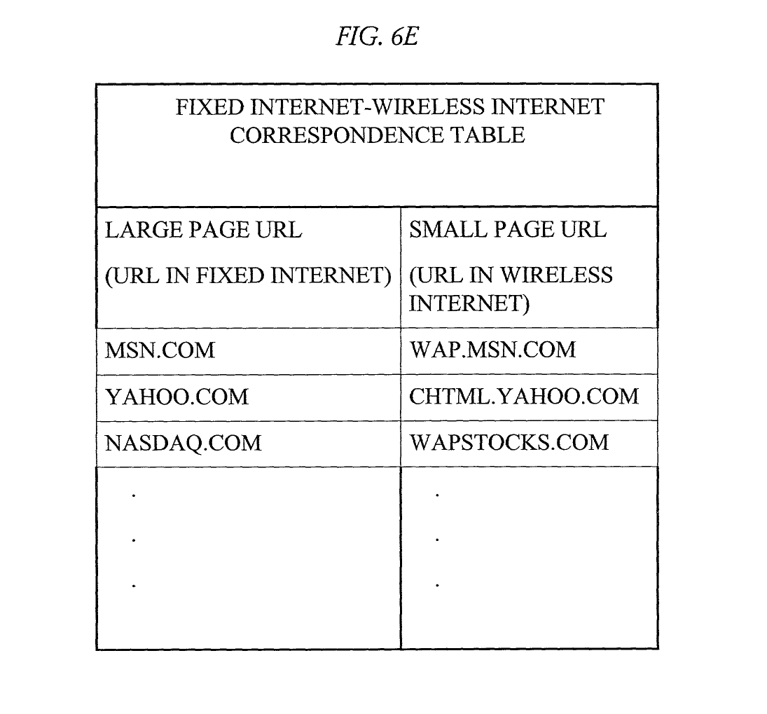

FIGS. 6A-6E are diagrams of tables included in the user preference database 210 of FIG. 5. The user preference database may for example be based on Microsoft's SQLServer.

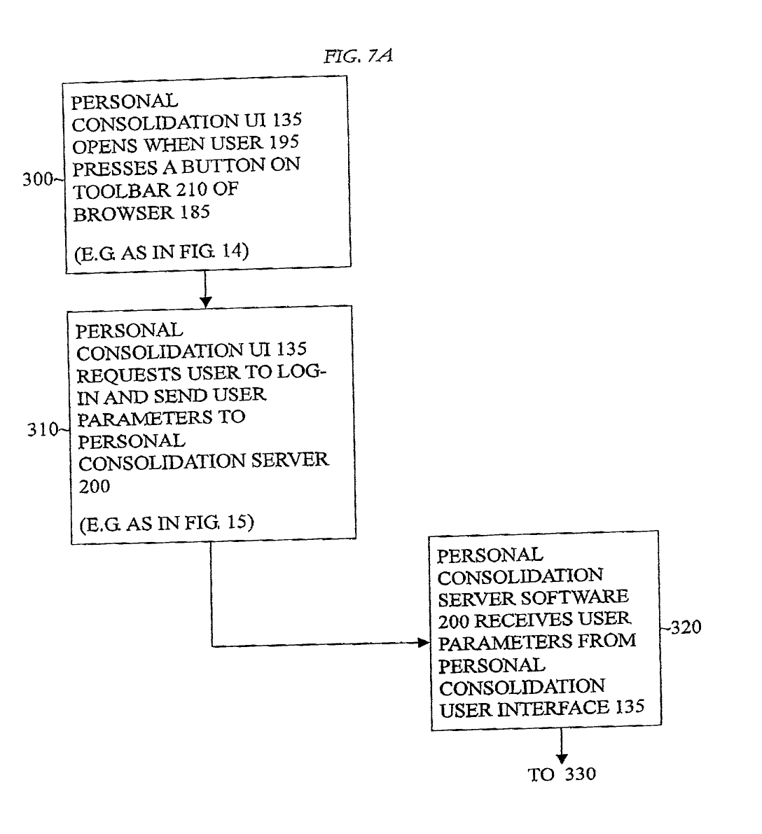

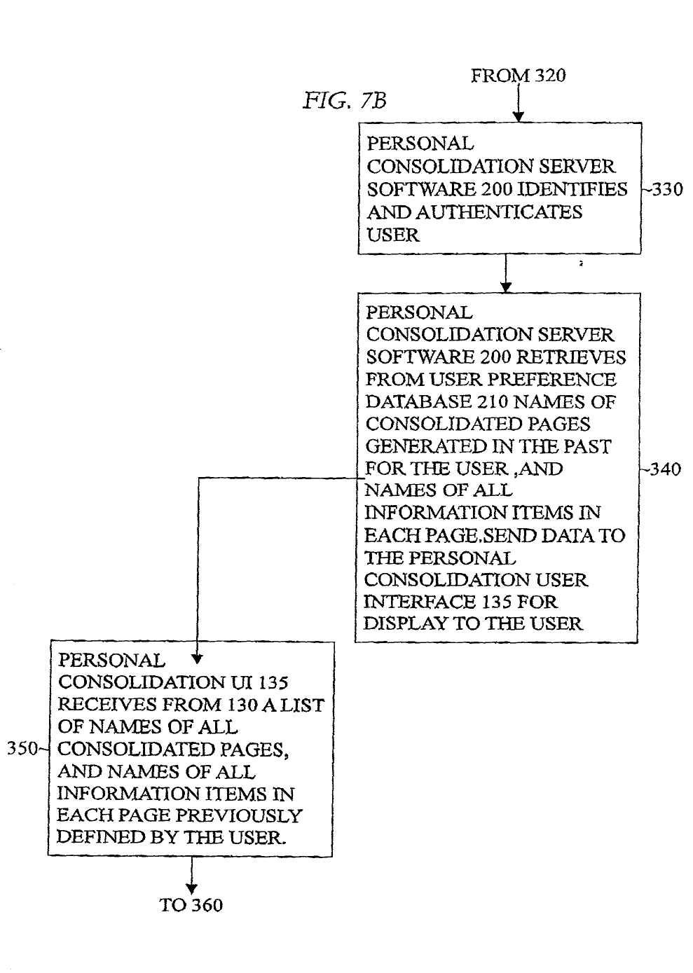

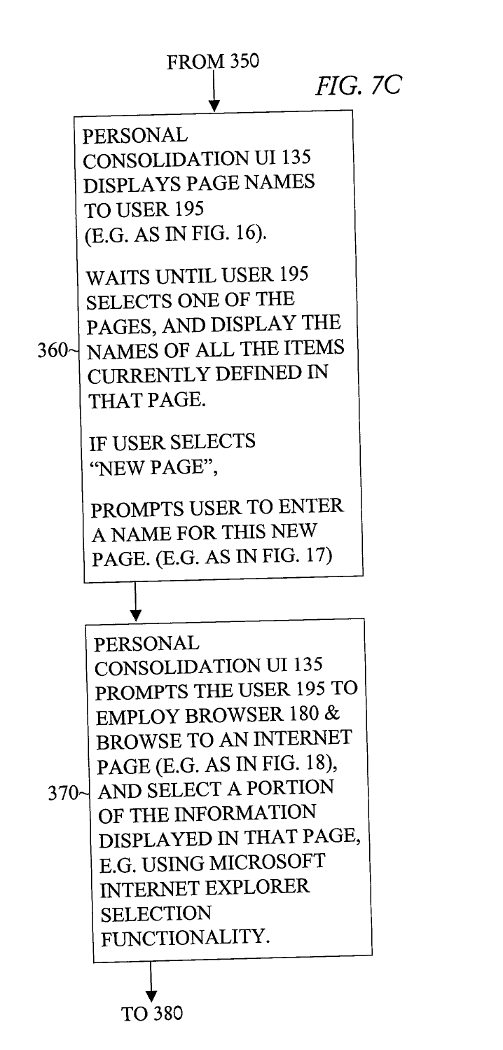

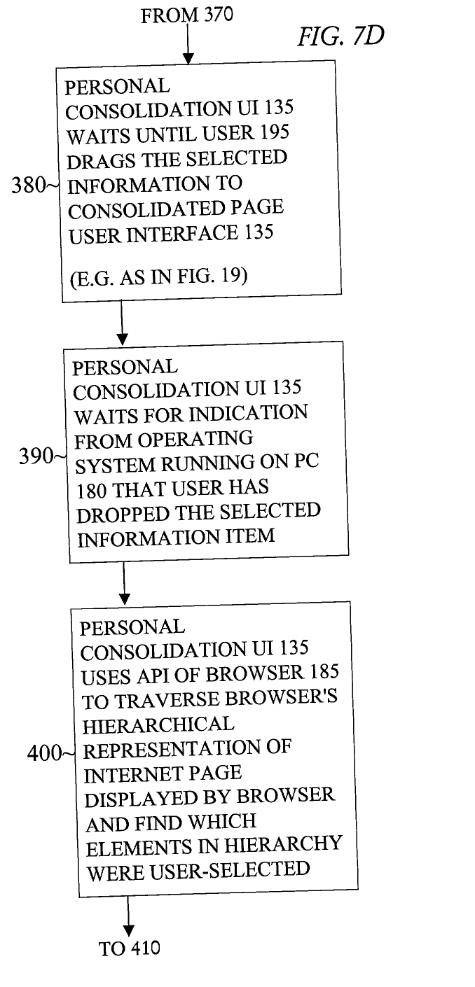

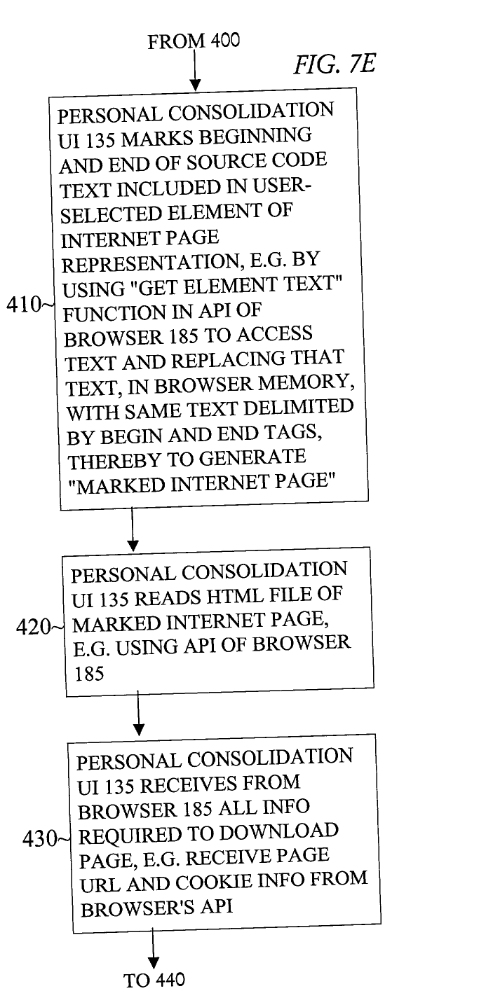

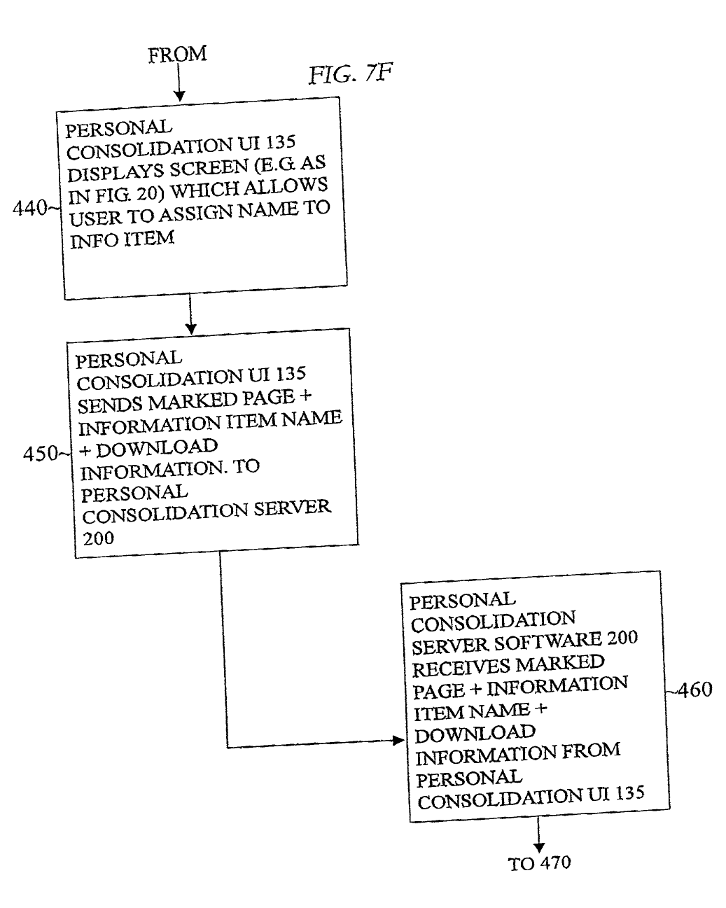

FIGS. 7A-7G, taken together, form a simplified flowchart illustration of the operations of user interface 135 (left column) and server software 200 (right column) in FIG. 1, in the course of a consolidated personal page definition session.

FIGS. 8A-8C, taken together, form a simplified flowchart illustration of a preferred content extraction and displaying method performed by the server software 200 responsive to a suitable request received from a mobile communicator device 190 serving a user 195 who has previously performed the content selection method of FIGS. 7A-7G.

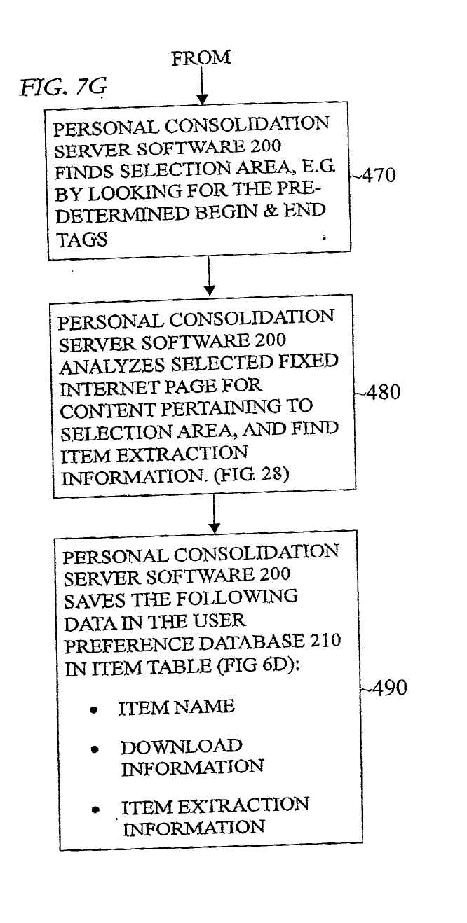

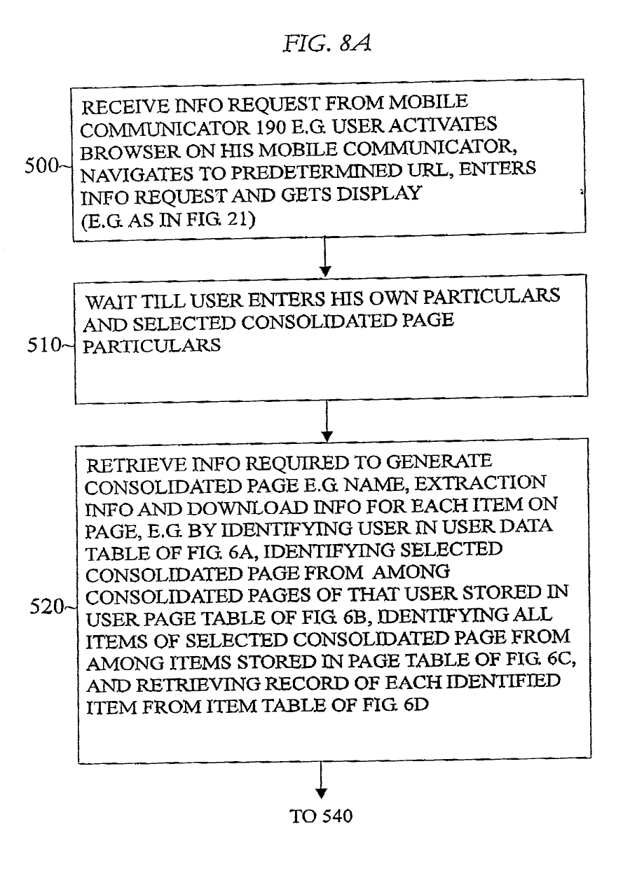

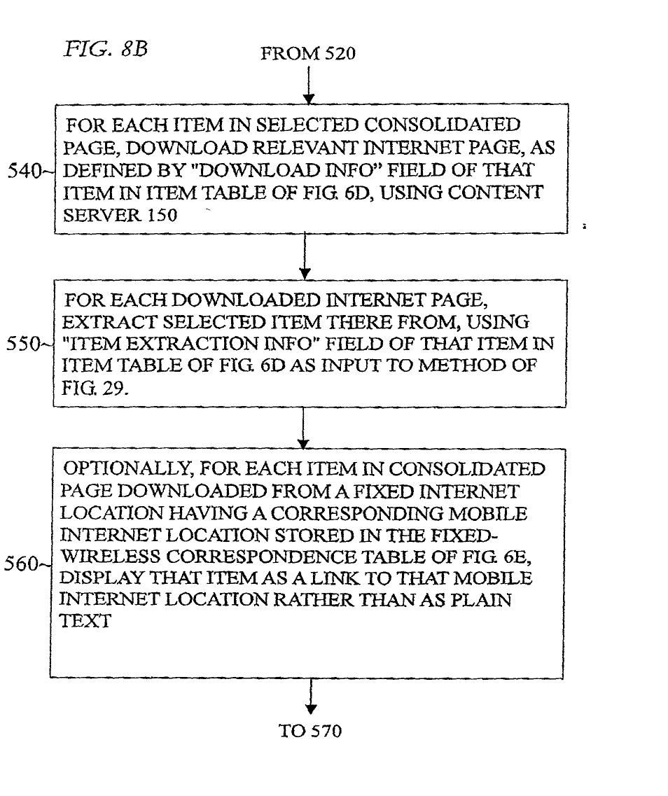

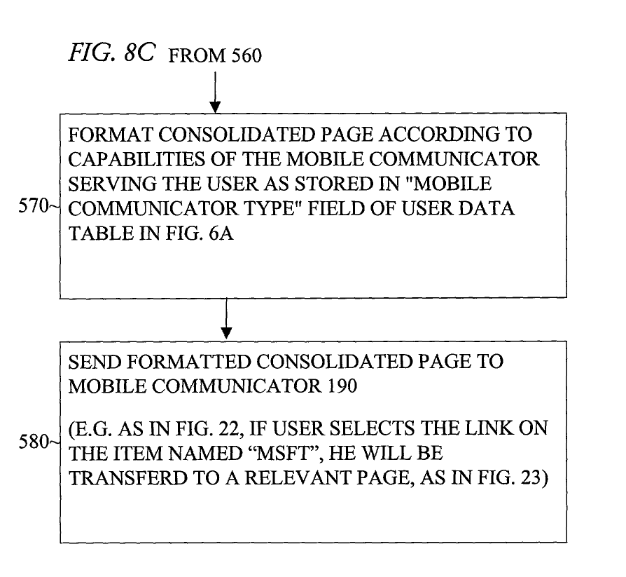

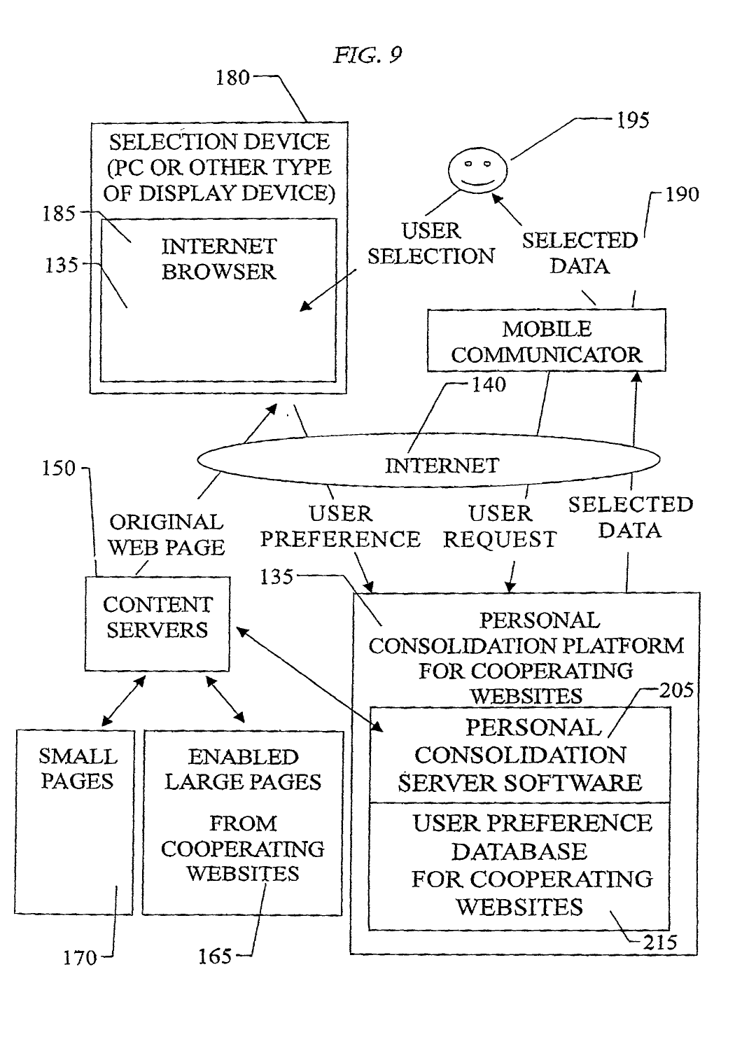

FIG. 9 is a simplified top-level functional block diagram of a mobile communicator content consolidation system constructed and operative in conjunction with cooperative websites in accordance with another preferred embodiment of the present invention. In the embodiment of FIG. 9, units 130, 200 and 210, which enable the user to select content from any, generally non-enabled website, are replaced by units 135, 205 and 215 respectively which assume cooperation on the part of the website e.g. as described in detail below. In the embodiment of FIG. 9, a reservoir of enabled websites is provided such that the user, without resort to customized client software, can generate a personal consolidated mobile page for himself with content items retrieved from among predefined content items residing within said enabled website pages.

As in FIG. 5, the system includes a personal consolidation platform computer 135 and is operative in conjunction with an information network 140 such as the Internet. The network 140 is associated with content servers 150 which typically each have access to a reservoir of information 170 suitable for display on display devices with a relatively small display area. Also associated with each content server 150 is a reservoir of enabled information 165 suitable for display on display devices with a relatively large display area.

The term “enabled” is used herein to refer to information posted in cooperating websites which are constructed and operative to cooperate with the system of the present invention, rather than being naive websites which are not customized for cooperation with the system of the present invention. For example, the term “enabled” may mean that a plurality of small-screen information requesting locations are defined within the page, each location being associated with an input medium, such as but not limited to a button or a link, which enables the user to request a display, on his mobile communicator or other small screen device, of information associated with that location. Typically, the small-screen information requesting location bears a suitable message such as one of the following:

a. A simple message superimposed onto or positioned adjacent an information item, indicating that that information item can be added to a user's consolidated page.

b. A related-information message superimposed onto or positioned adjacent an information item, indicating a type of related information that can be added to a user's consolidated page. For example, a news site may have a button offering the user headlines of the news site. A sports site may have several buttons or links such as the following: “get betting odds for team's next game” (positioned next to information regarding a particular team) , “get ticket info for next game in this stadium” (positioned next to information regarding a particular game in a particular stadium).

An example of suitable parameters for a button implementing a small-screen information requesting location as above is as follows:

a. Content extraction URL (also termed herein, more generally, “download info”)—The URL of the “source site” from which information is to be extracted;

b. Content extraction tags (also termed herein, item extraction tags)—Delimitation (e.g. beginning and end tags) of the information in the source site which corresponds to the small-screen information requesting location. Alternatively, the “content extraction tags” parameter (b) may be replaced by a “function name” parameter, identifying a function that can be called by server 200 using a suitable protocol such as SOAP. The function provides the server with suitable extraction information.

c. (Optional) Relevant wireless link URL (“wireless link”)—The URL of a related wireless Internet page. If designated, the information added to the user's consolidated page comprises a link to that URL rather than a plain text addition.

d. (for buttons) Post command address—URL of Internet server 205, i.e. URL of Internet server to which parameters (a)-(c) are to be sent responsive to user pressing the button.

e. Small-screen information item name (“item name”)—a title for the small-screen information requested which is to appear on the small screen adjacent the information.

The reservoir of information 165 typically serves personal computers 180 via Internet browsers 185 and other computers having a relatively large display. Reservoir 165 typically supports html-type languages.

A preferred method for generating enabled pages for storage in reservoir 165 is now described. The method employs HTML and Java techniques to enable a previously naive website for use with a Personal Consolidation Platform constructed and operative in accordance with a preferred embodiment of the present invention.

Enabling content typically comprises the following two steps:

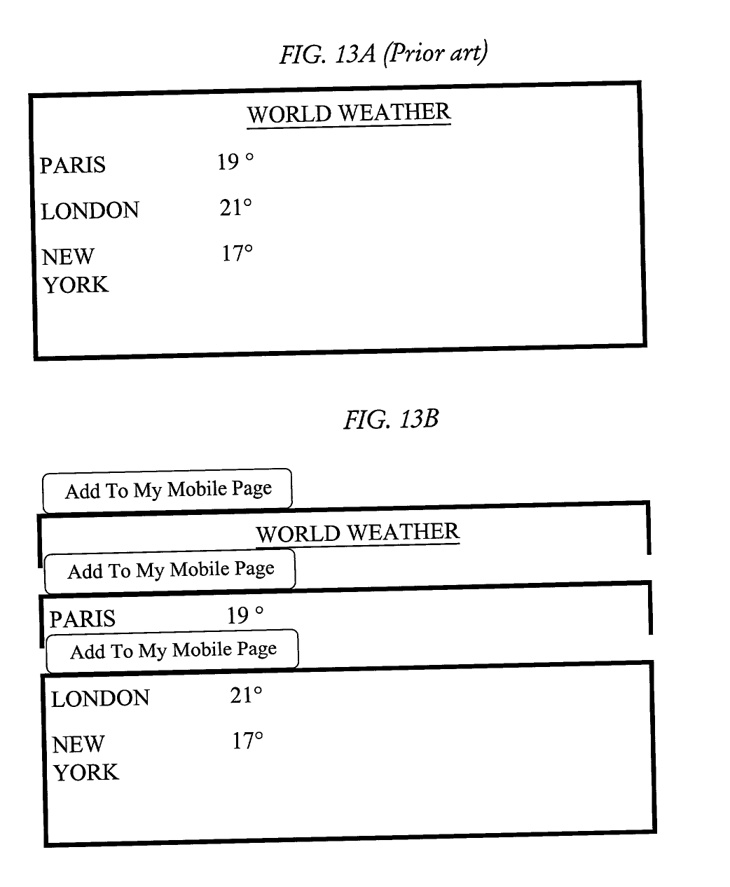

I. Adding a button in the original content, to be used by the user to indicate that he would like to add some content from the enabled page to his personal page. For example, original content of a world weather page is shown in FIG. 13A and the same page, after three buttons have been added is shown in FIG. 13B.

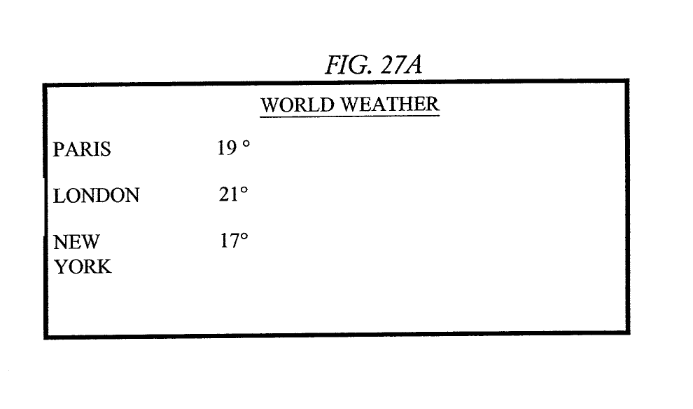

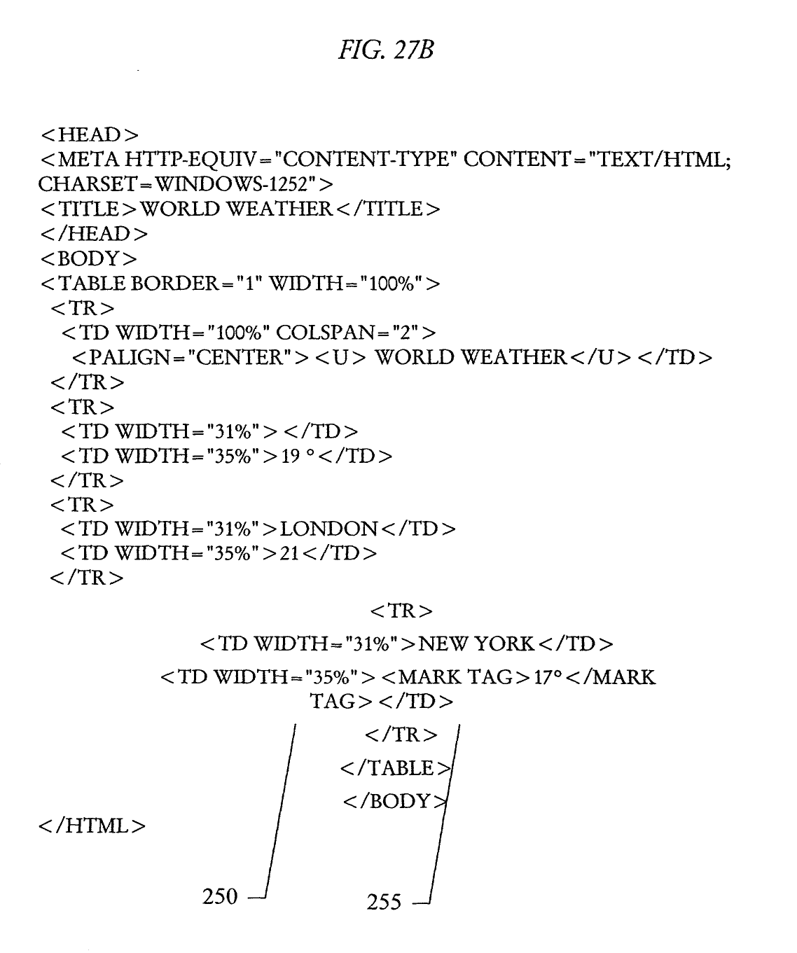

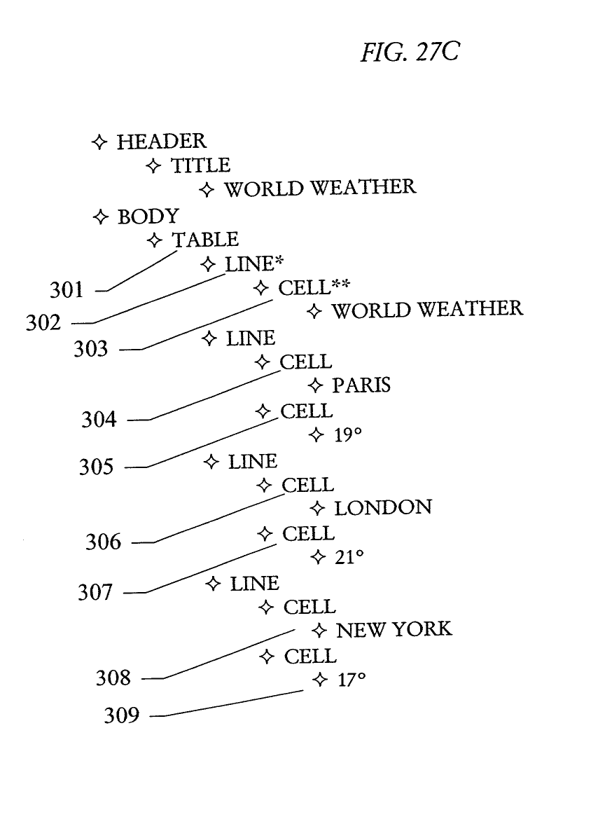

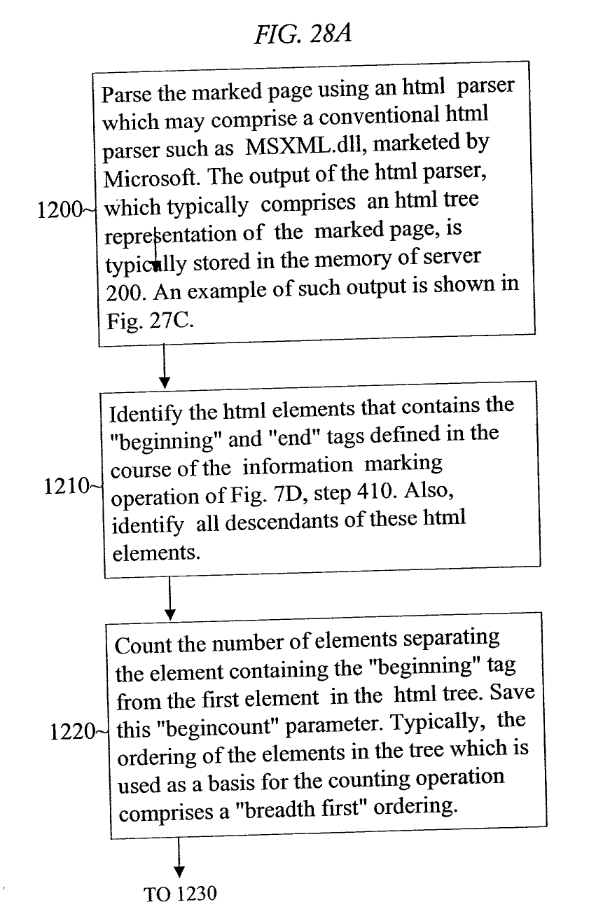

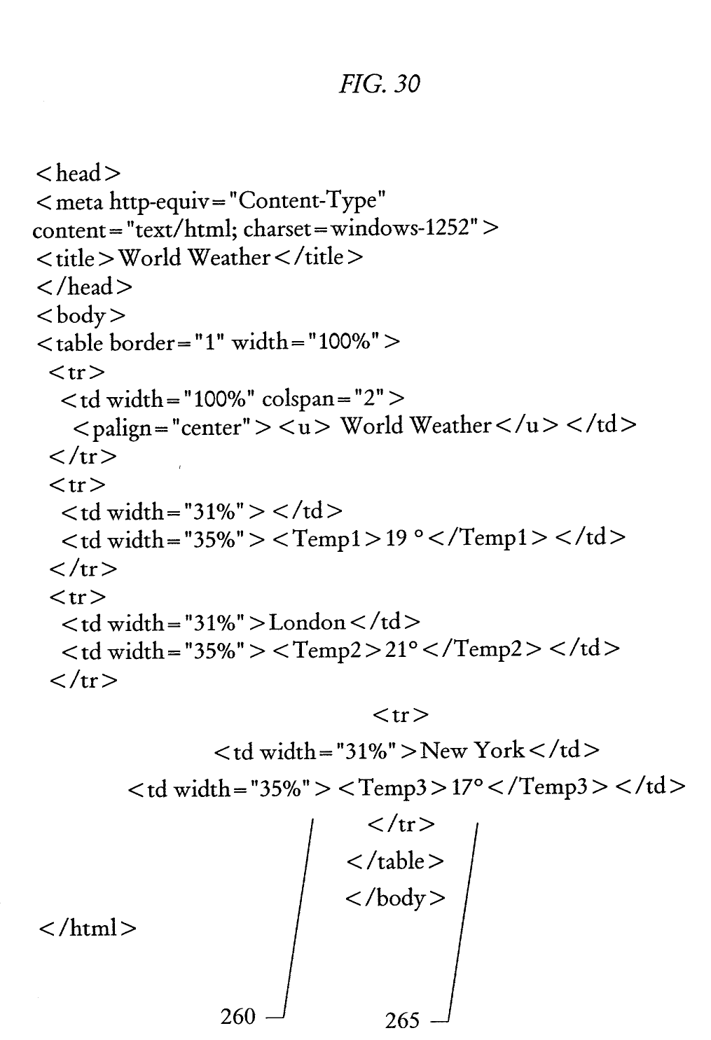

II. Adding a content extraction tag, to delimit the content that is to be displayed on the mobile device, responsive to activation of a corresponding button or link by the user. For example, in FIG. 30, content extraction tags temp1, temp2 and temp3 which are typically unique to the page, have been added to the page to delimit each of the 3 temperature values seen in FIG. 27A.

Once the user presses the new button, the user's browser 185 issues a post command to the content servers 150. This command typically includes all parameters used to identify the information item the user would like to receive on his Personal Mobile page. Responsive to this command, the Server 150 opens a new browser window, authenticates the client, and lets him select a consolidated personal page to which the new information item is to be added.

When the user requests his personal page from the mobile device, the server 150 accesses the original content sites, download the relevant pages, and extracts from each page the information delimited by content extraction tags.

After the information from all relevant enabled pages is extracted, the consolidated page is formatted to the capabilities of mobile communicator device 190 and the device's protocol (such as SMS, WAP or others) and the consolidated page is sent to the communicator device 190.

Adding a button to the original content is typically carried out by performing the following substeps a and b:

a. Include mPrestInclude.JS, which is stored in the CD-ROM appended herewith, into the page to be enabled

b. Put the button at an appropriate location, and call MP_Add( ) on the OnClick event. Set The MP_Add( ) parameters as follows: MP_Add ( )

StrExtractUrl—Url of the page from which the information item is to be extracted. The page from which the information item is extracted may be the page being enabled, or some other page.

StrExtractTagName—Tag to surround the information item that is to be extracted

strMobileLink1—the link that this information item points to on the phone.

A preferred method for adding a content extraction tag (step II above) is as follows: All text to be displayed by the mobile device is typically delimited by a content extraction tag which is typically unique on the specific page. The tag typically corresponds to the tag specified when the MP_Add( ) function was called (step b above). In the illustrated example, as shown in FIG. 30, a unique tag is added around each of the three “temperature” information items shown in FIGS. 13A-13B.

Referring back to FIG. 9 it is seen that as in FIG. 5, the reservoir of information 170 typically serves mobile telephones and other mobile communicators 190 with relatively limited display capabilities and typically supports limited mark-up language protocol, including wml and chtml and not including html-type languages or including only certain formats of html-type languages which formats are particularly suited to limited display capacity devices.

The personal consolidation platform computer 135 of FIG. 9 typically comprises personal consolidation server software 205 and user preference database 215.

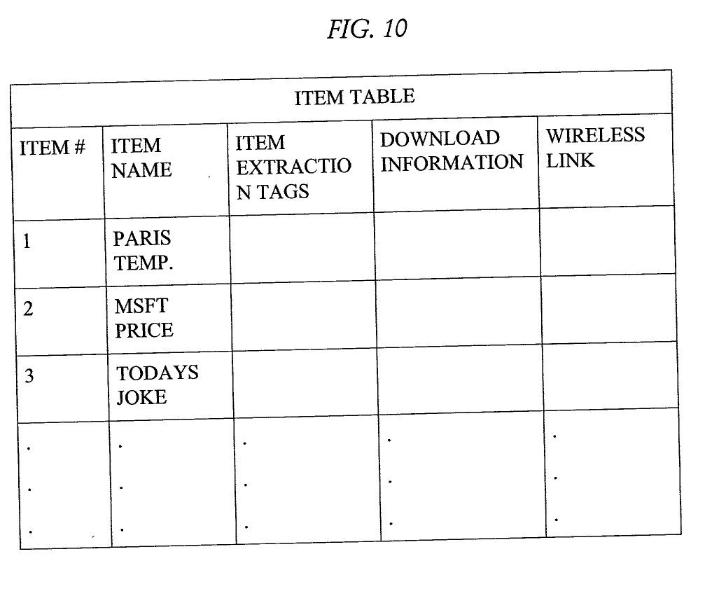

FIG. 10 is a diagram of a table included in the user preference database 215 of FIG. 9. The user preference database 215 may for example be based on Microsoft's SQLServer and typically also comprises the tables of FIGS. 6A-6C.

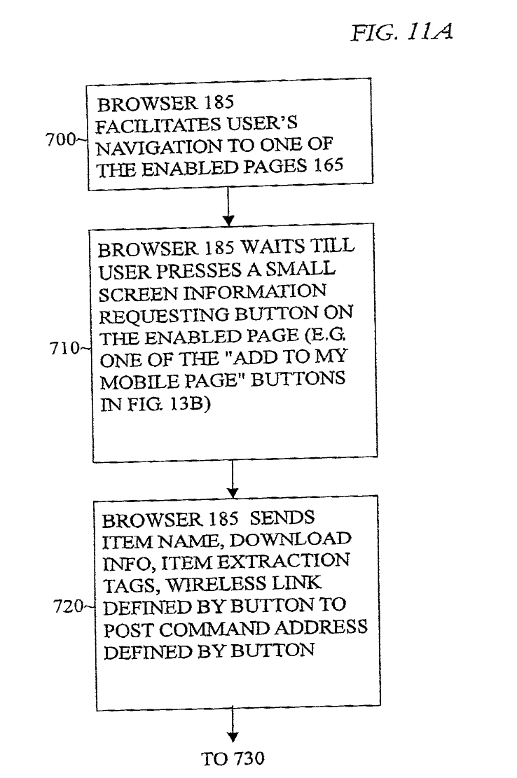

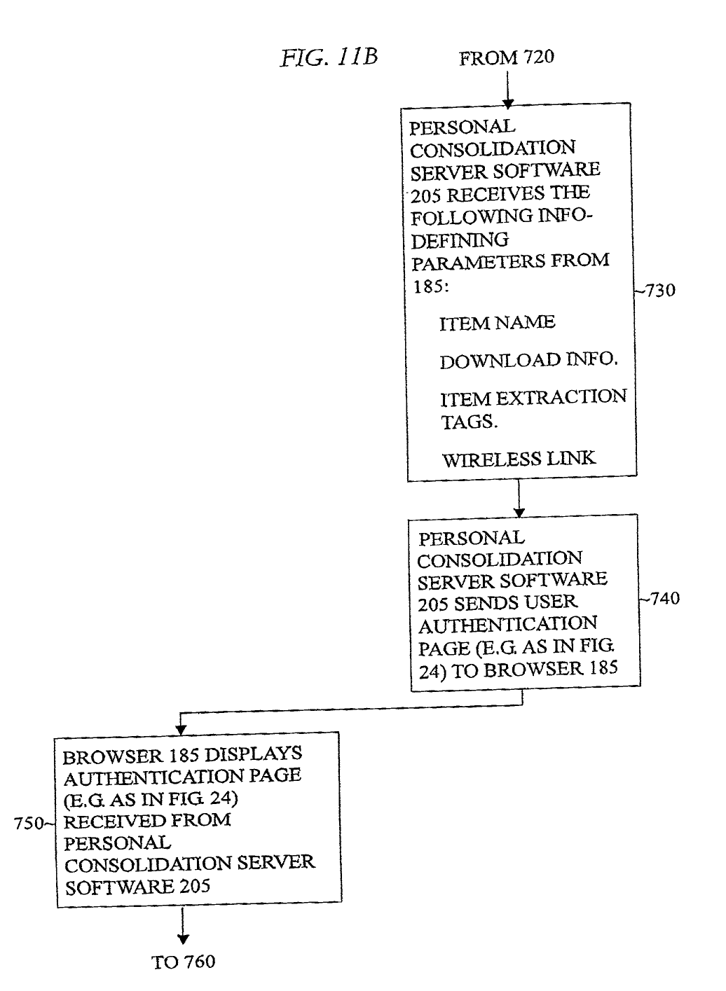

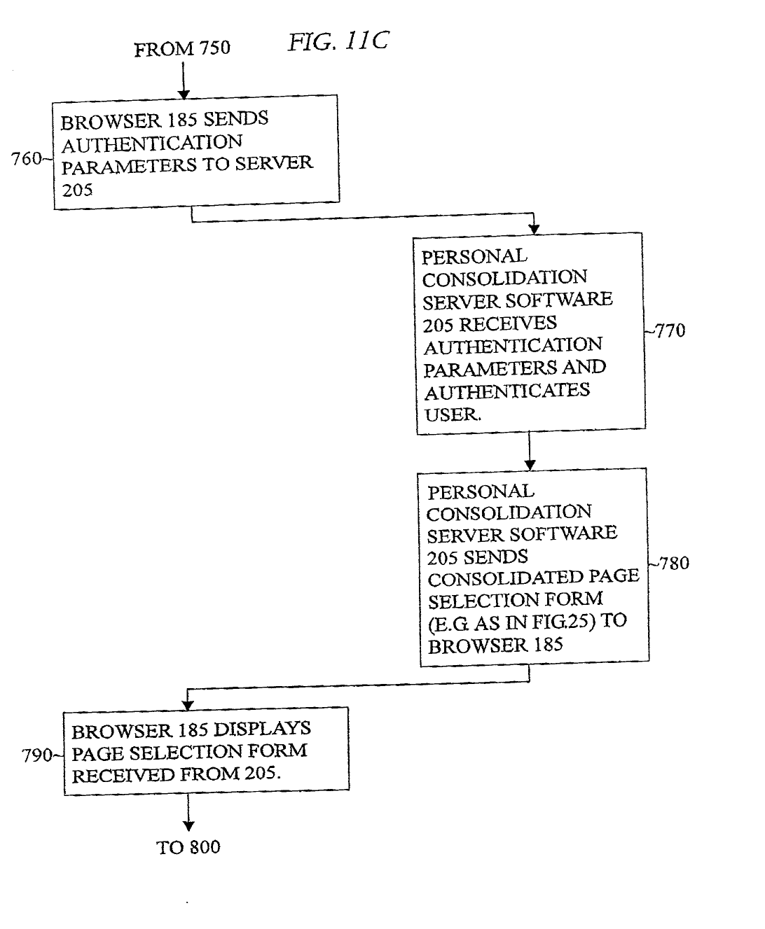

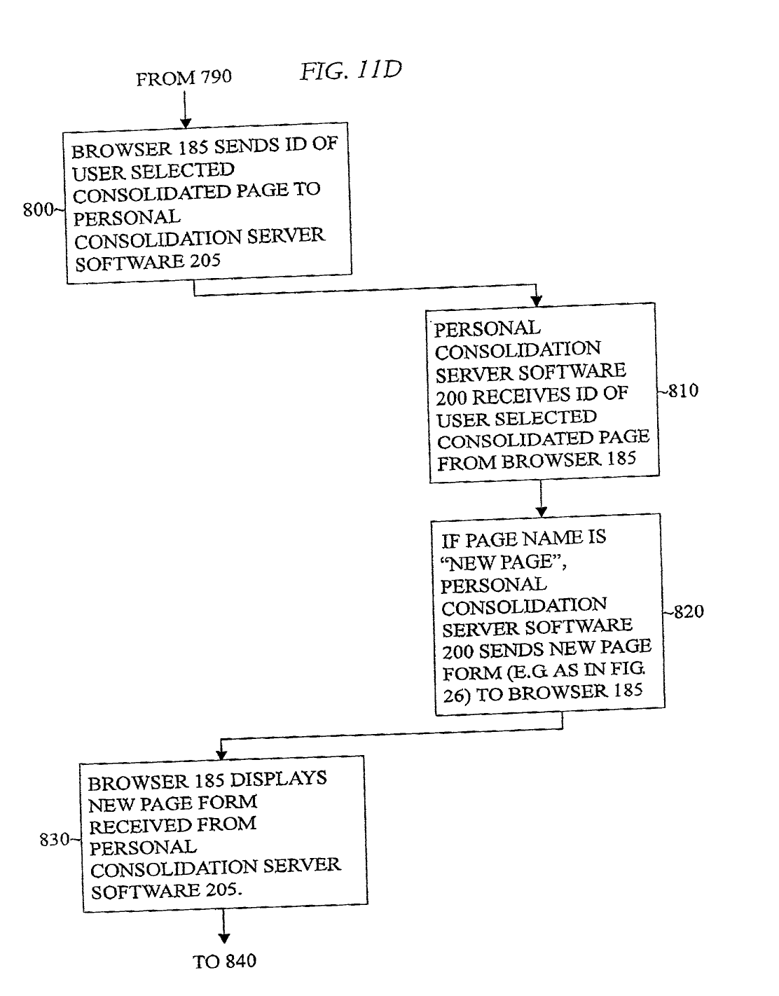

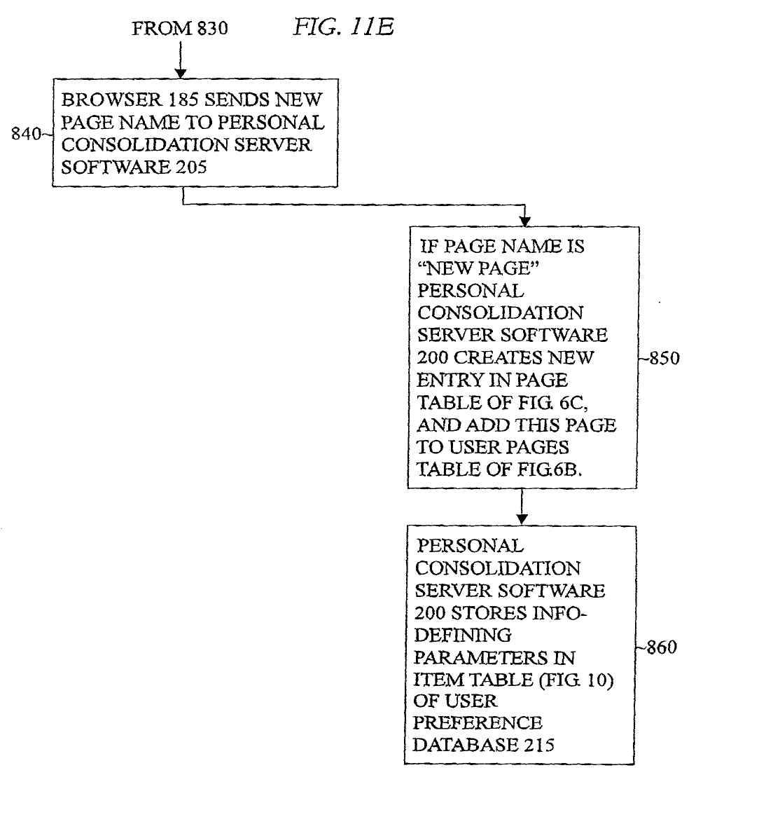

FIGS. 11A-11E, taken together, form a simplified flowchart illustration of the operations of server software 205 in FIG. 9 (left column) in conjunction with (right column) a conventional browser 185 such as Microsoft Internet Explorer, in the course of a consolidated personal page definition session.

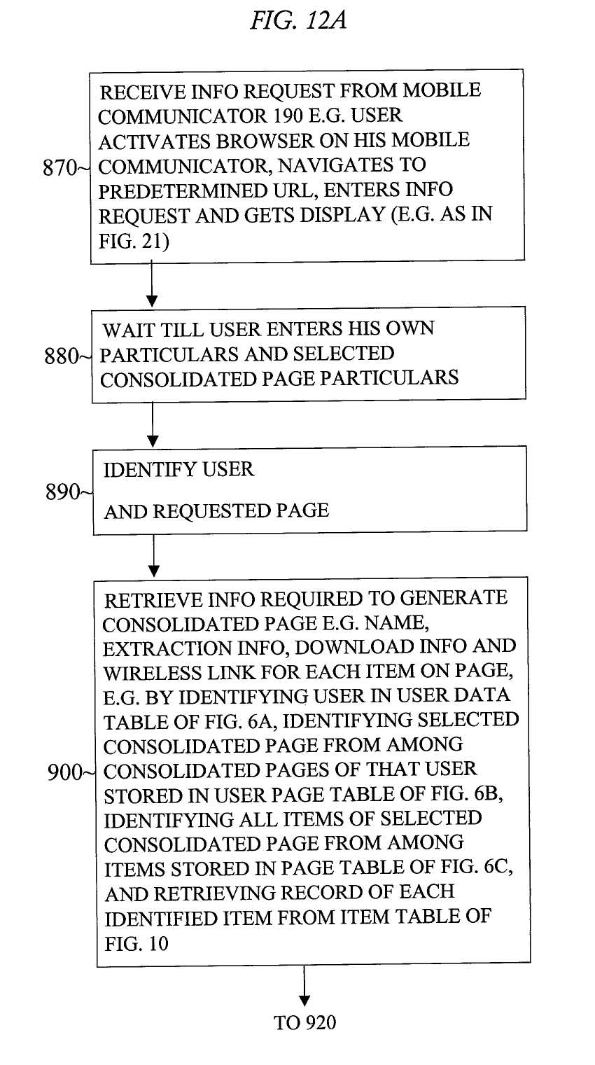

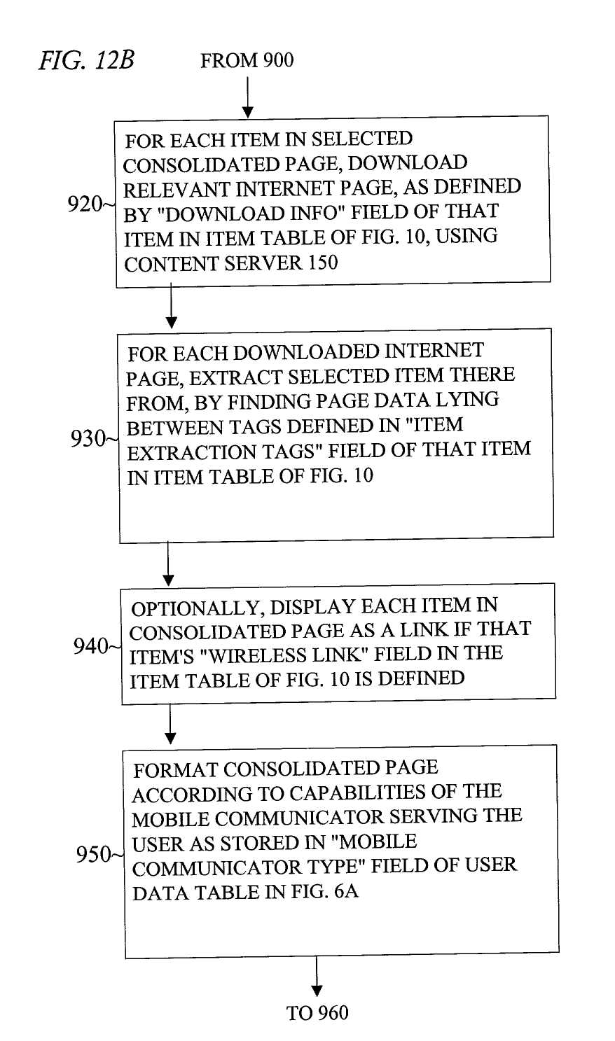

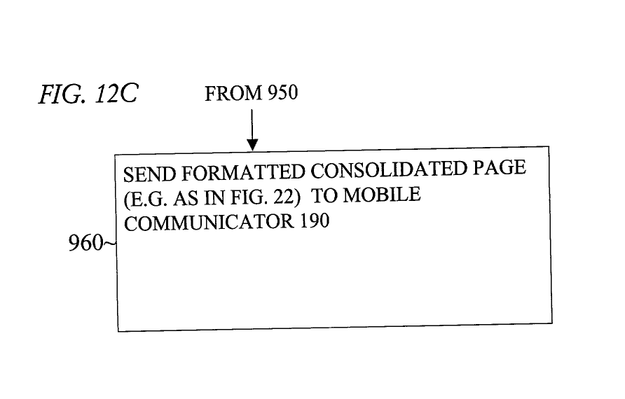

FIGS. 12A-12C, taken together, form a simplified flowchart illustration of a preferred content extraction and displaying method performed by the server software 205 responsive to a suitable request received from a mobile communicator device 190 serving a user 195 who has previously performed the content selection method of FIG. 11.

FIG. 13A is a simplified pictorial illustration of a naive large Internet page.

FIG. 13B is a simplified pictorial illustration of a enabled large Internet page which may be generated from the naive Internet page of FIG. 13A.

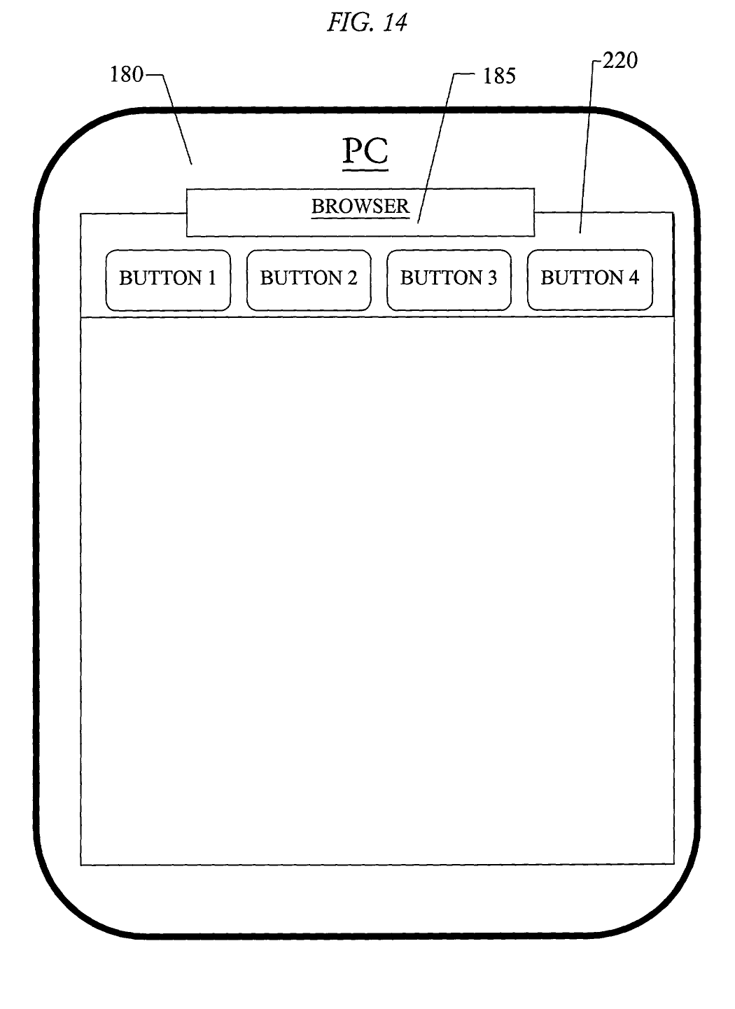

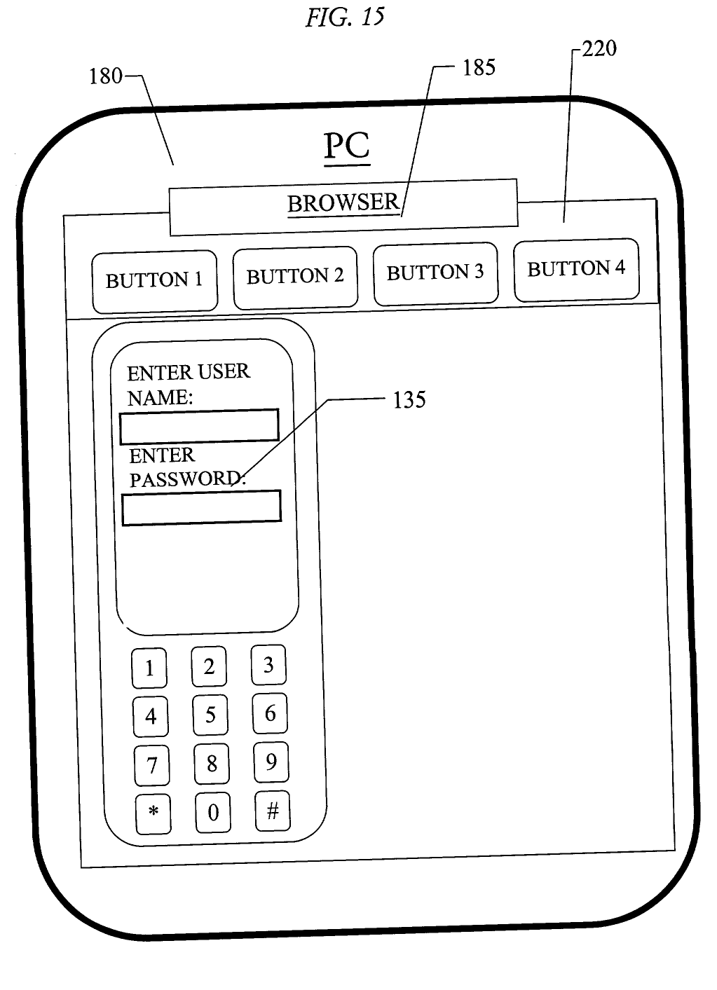

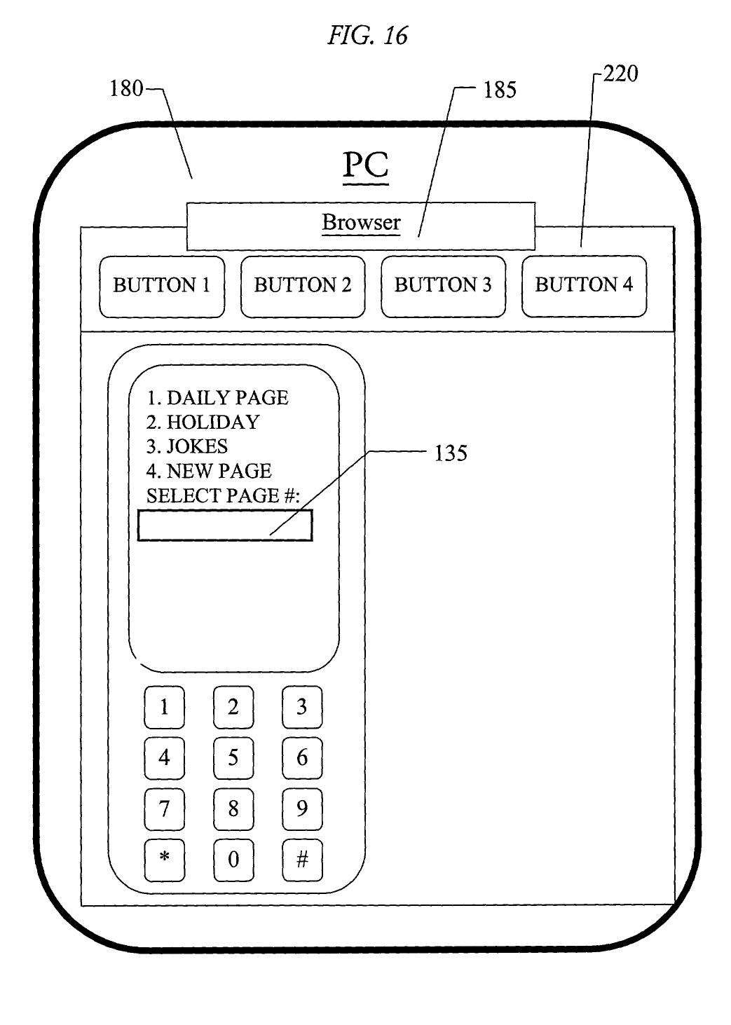

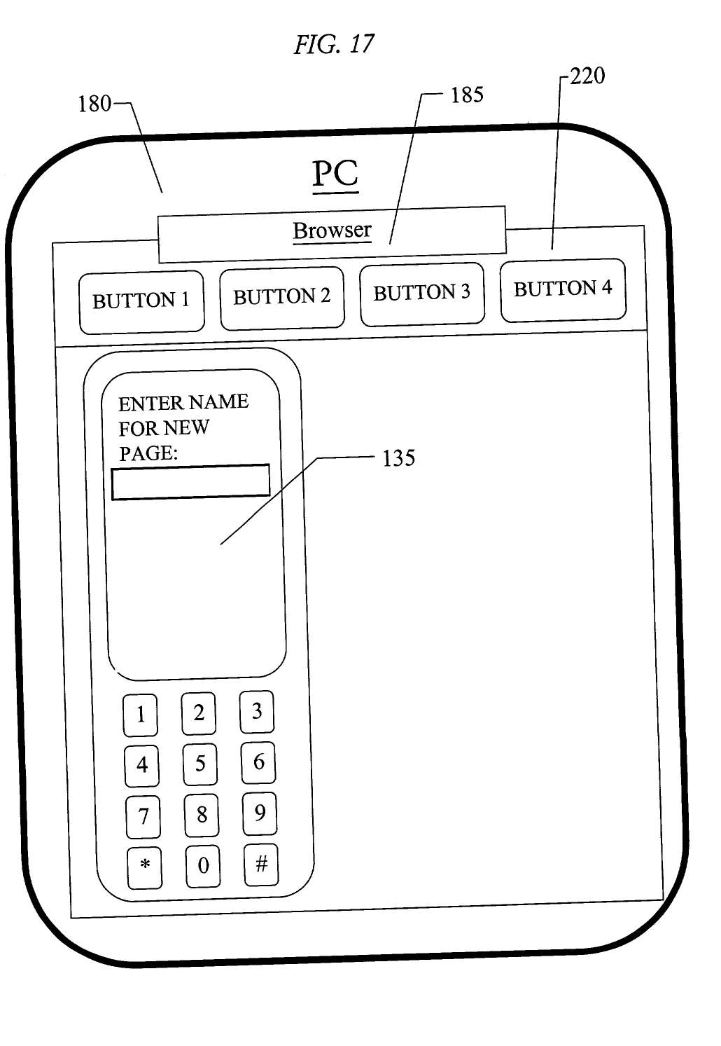

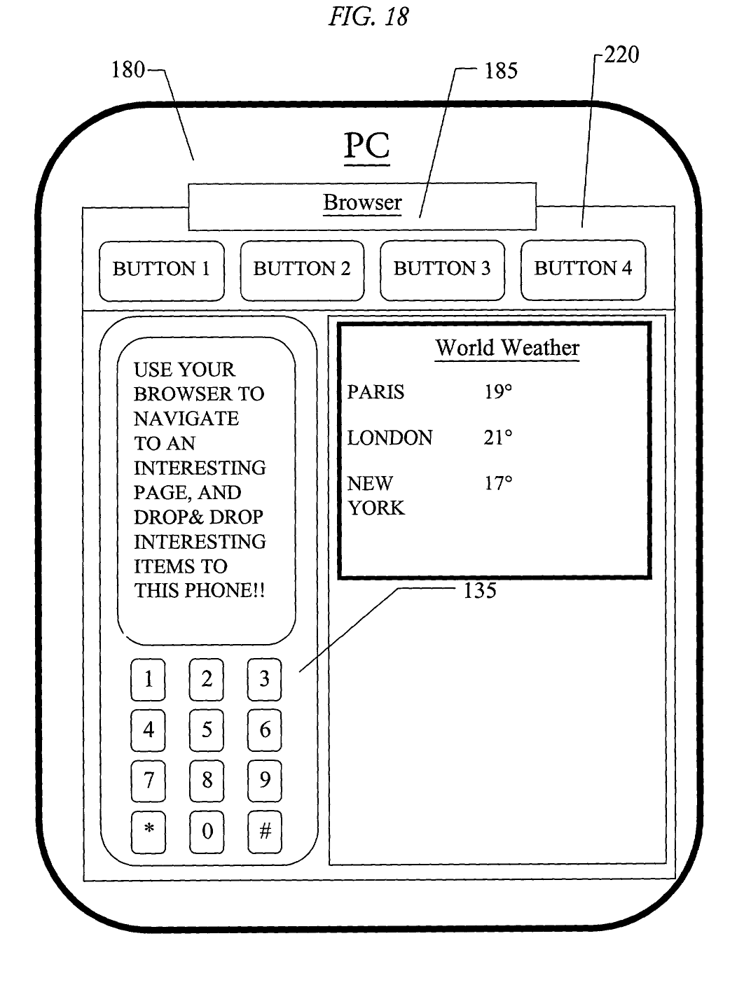

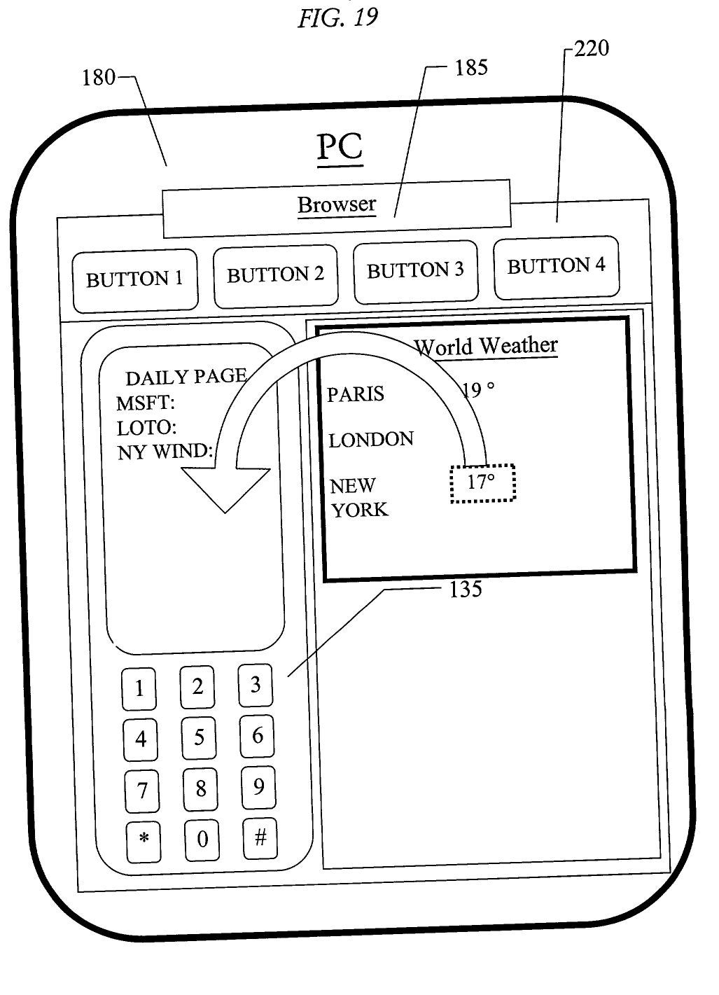

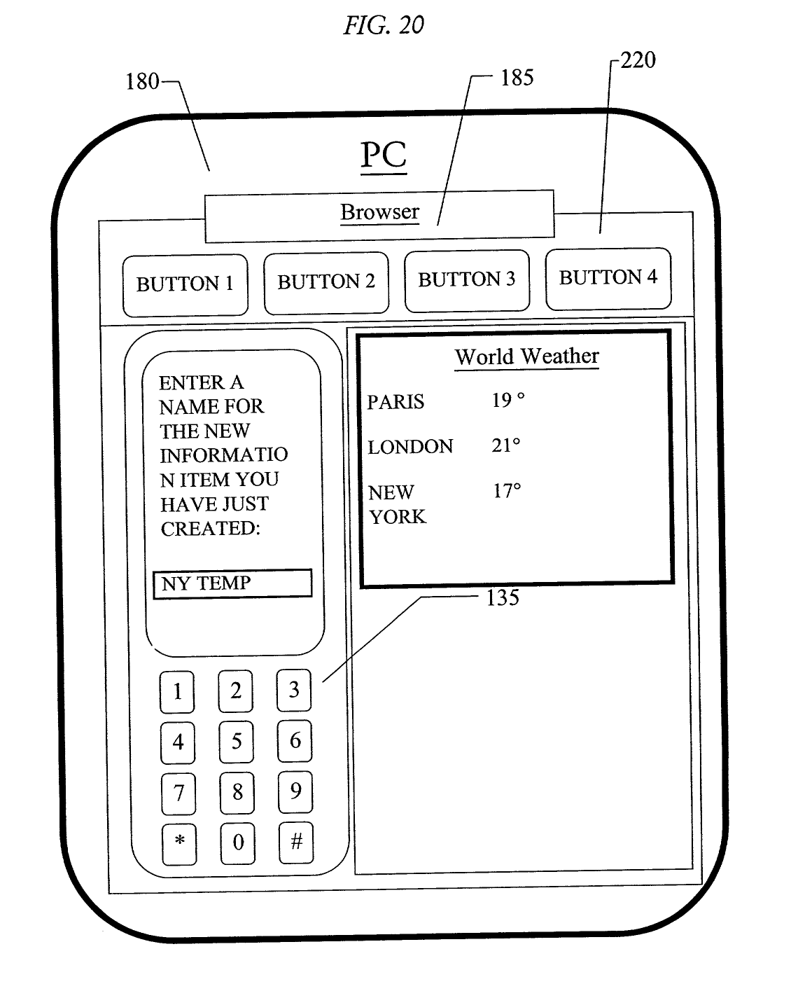

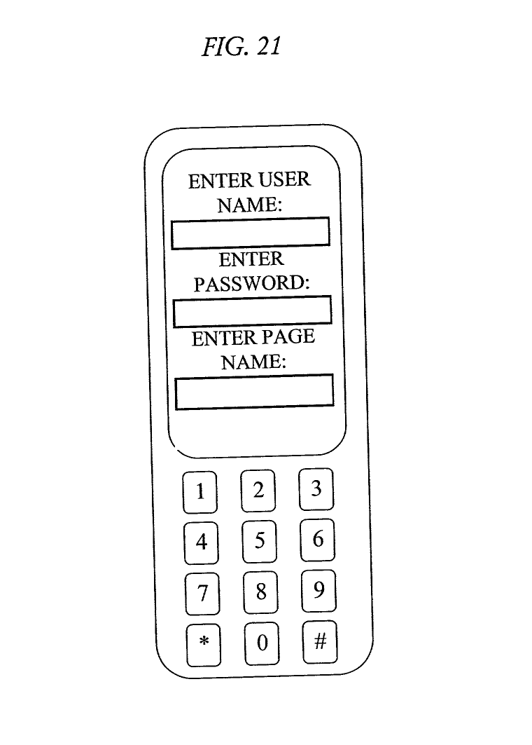

FIGS. 14-20 are simplified pictorial illustrations of screen displays generated by personal consolidation user interface 135 in FIG. 5 in the course of performing the method of FIGS. 7A-7G. The buttons are typically installed by each of the plug-ins that the user has downloaded.

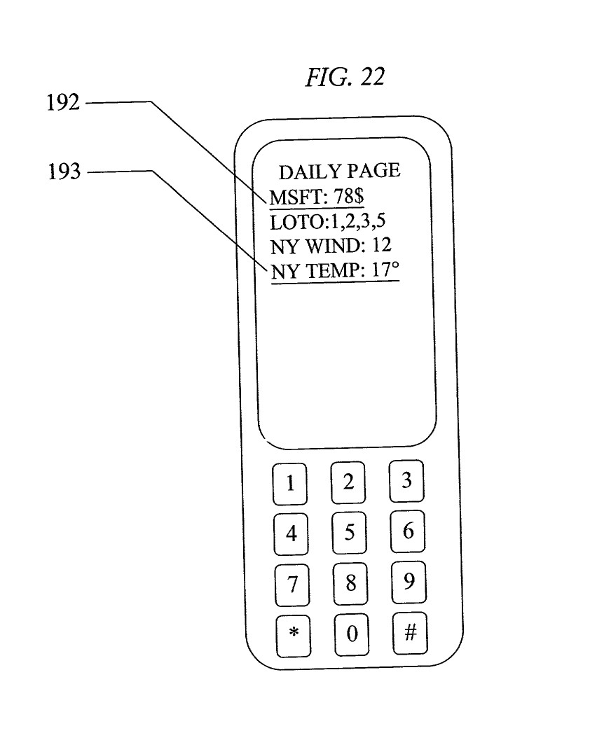

FIGS. 21-23 are simplified pictorial illustrations of screen displays generated by the mobile communicator 190 in FIG. 5 in the course of performing the method of FIGS. 8A-8C.

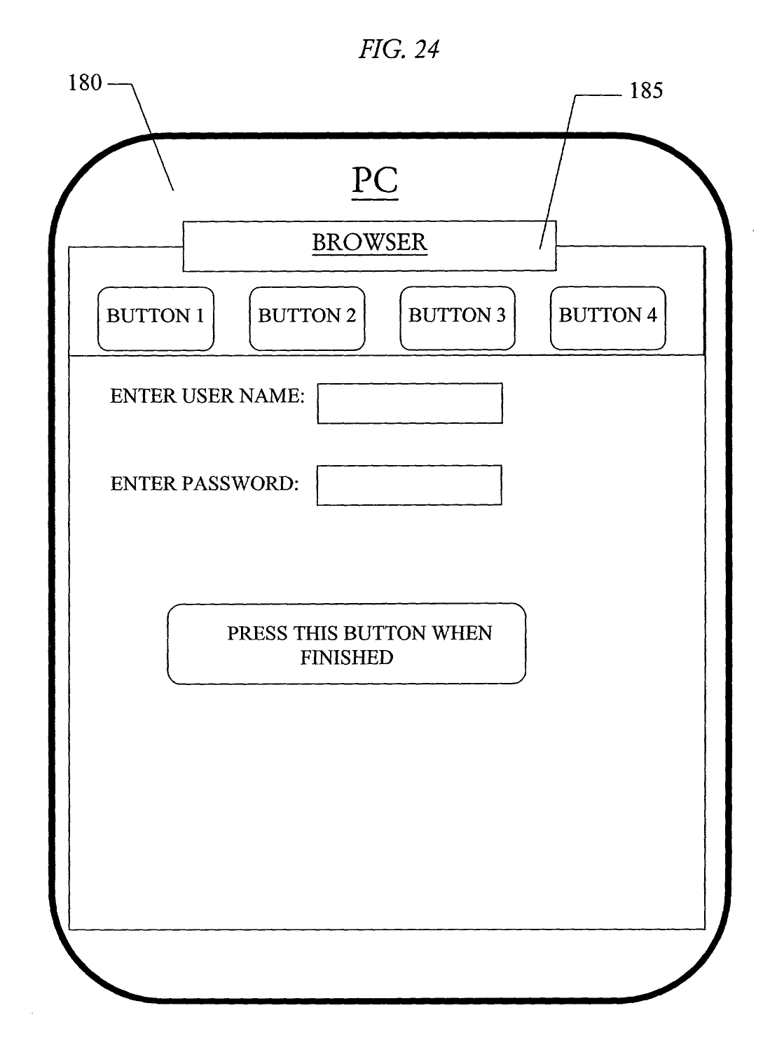

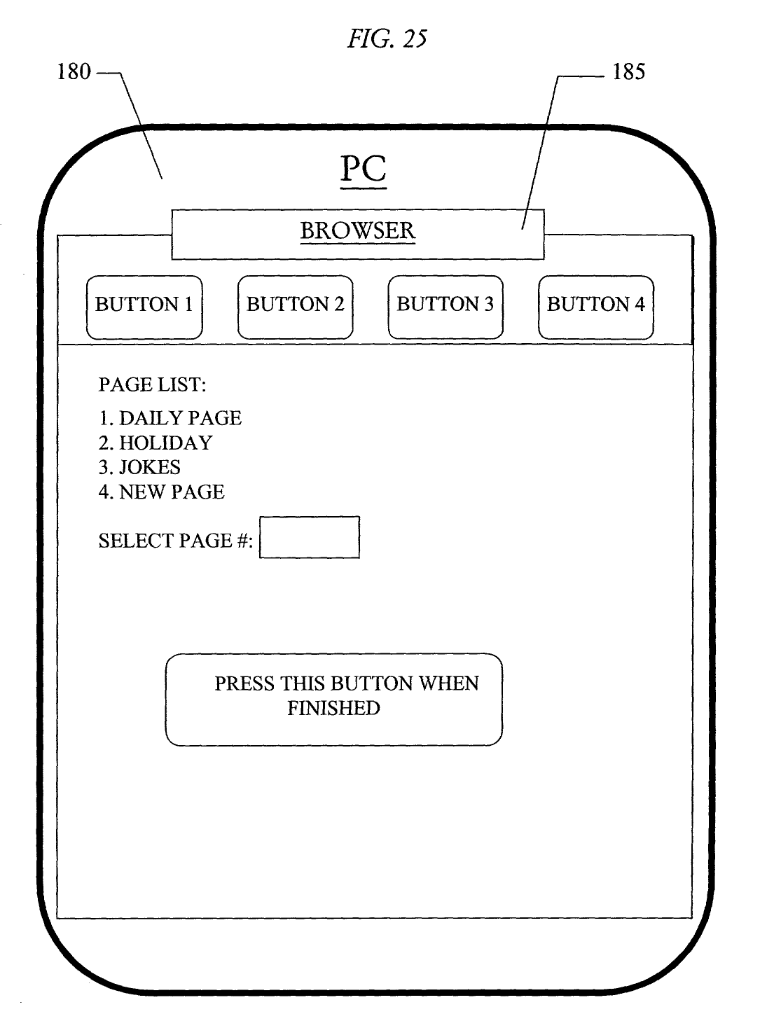

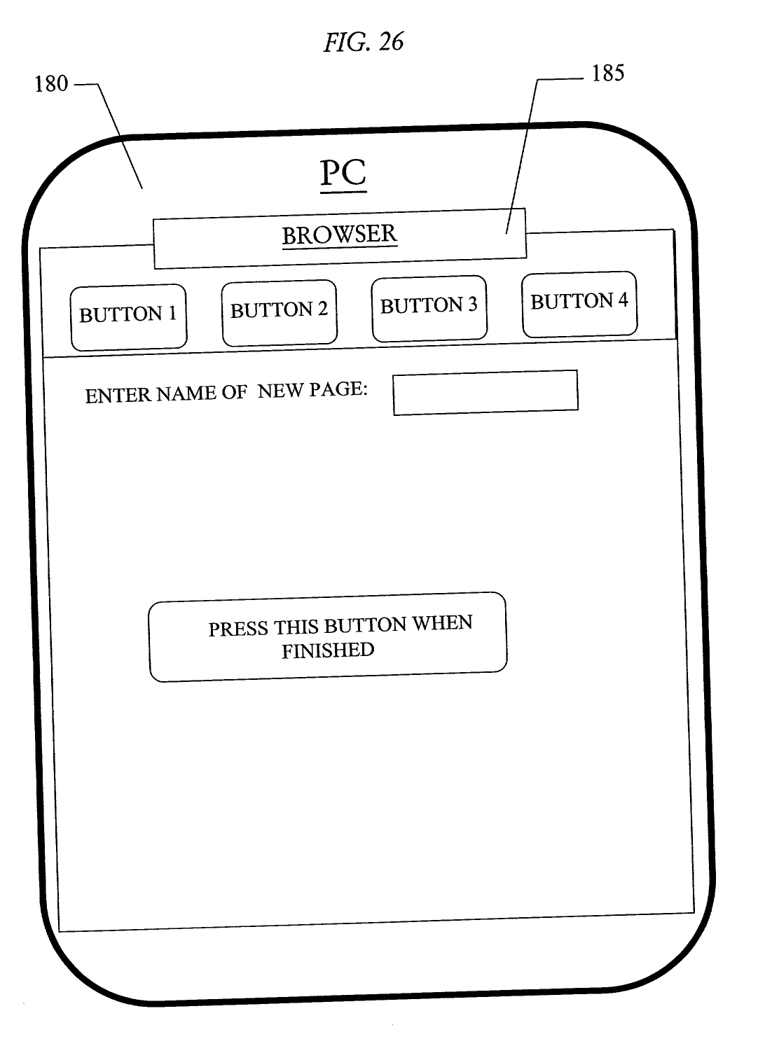

FIGS. 24-26 are simplified pictorial illustrations of screen displays generated by browser 185 in FIG. 9 in the course of performing the method of FIGS. 11A-11E.

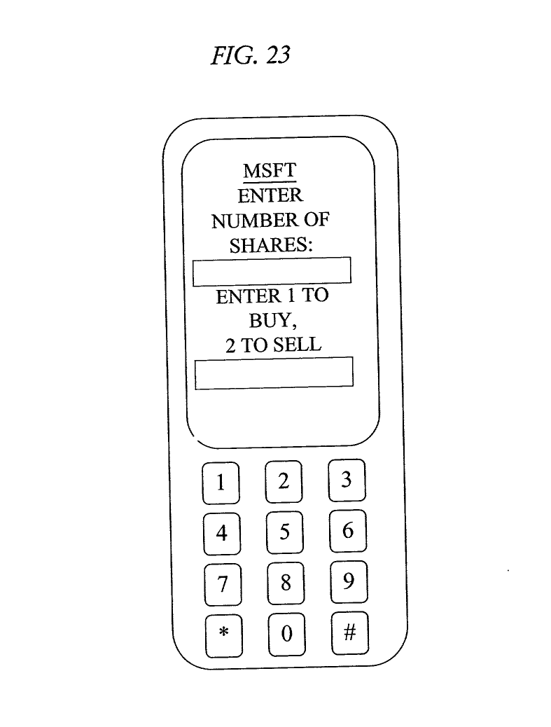

An example of a mobile communicator displayed consolidated page is shown in FIG. 22. As shown, the consolidated page includes a plurality of information items typically culled from a corresponding plurality of fixed Internet pages as described in detail herein. Each information item may either be displayed as plain text or, as indicated by underscoring in FIG. 22, may comprise a link to a mobile Internet website associated with the displayed information item. In the illustrated example, in FIG. 22, there are two links, MSFT and NY Temperature. Selecting the MSFT link typically brings the user directly to an MSFT stock trading “small page” within a wireless Internet (“small page”) stock trading website, as shown in FIG. 23, because typically, the link need not be a general link to a wireless Internet website but rather may be a link to a specific page within the wireless Internet website. This feature is particularly suitable for instances in which the user-selected information item is pertinent to a particular page within a wireless Internet website rather than to the website as a whole.

Referring back to link-providing steps 560 in FIG. 8B and 940 in FIG. 12B, it is appreciated that each link may comprise not only the address of an underlying mobile internet website but rather, additionally, parameters facilitating use of the website by the user in question.

It is appreciated that according to a preferred embodiment of the present invention, a high degree of information selectivity is provided in the information selection functionality shown and described herein, typically at the sub-page level and even, if desired, at the sub-HTML tag level such as the sub-table level or even the sub-cell level, where the term “cell” is used to refer to an entry within a table of information. This selectivity is advantageous in that even a small display area becomes very efficient in its information display capabilities, simply by focussing exclusively on the information specifically required by the user, and not displaying any other information which from this particular user's point of view, is superfluous. A particular advantage of the information selectivity characteristic is that many information items can be targeted by the user for consolidation into a relatively small space.

As a result, use of Internet in general, and mobile Internet in particular, becomes much more attractive to the user. This is because the present invention greatly reduces the number of keyclicks a user must perform in order to “find the needle in the haystack” i.e. to access and react to the specific items of information that are of interest to him, from among the vast number of such items which are available on Internet.

Preferably, the link to the underlying (linked) page comprises a deep link which has the effect of simplifying transactions by obviating the user's need to enter at least some of the parameters of the transaction. For example, the link provided on a user's consolidated page from a stock price to that stock's page on a stock trading site typically obviates the need for the user to enter the name of the stock and, optionally, to enter his user name at the stock trading site. Another example is that a user may elect to incorporate an auction bid information item onto his consolidated page. Responsively, the system may display that item, on his consolidated page, as a link to a page, within a general auction house website, which page is associated with the lot associated with the bid. This obviates the need for the user to enter the lot number and, preferably, also obviates the need for the user to enter his username because his username is automatically defined, by the system of the present invention, as a link parameter.

FIG. 27A is a pictorial illustration of a marked fixed Internet page, comprising the conventional website page of FIG. 13A, on which has been marked an information item which is of interest to a user.

FIG. 27B is a pictorial illustration of the marked source code corresponding to FIG. 27A which typically is generated by the method of the present invention responsive to the user marking operation, as shown herein in FIG. 7D, step 410.

FIG. 27C is a diagram illustration of the output of an html parser which has parsed the marked page of FIGS. 27A-27B. As shown, the output comprises a plurality of elements, each of which have been assigned a Roman numeral to facilitate description herein. In FIG. 27C, the word “line” indicates the presence of a “Tr” html tag and the word “cell” indicates the presence of a “Td” html tag.

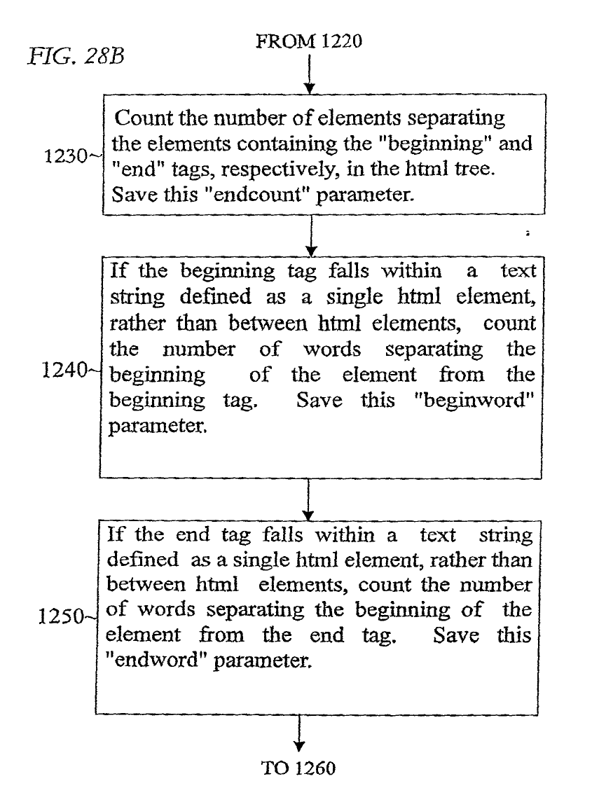

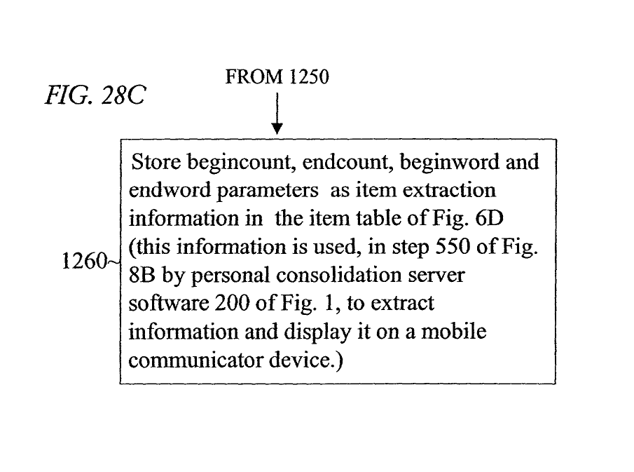

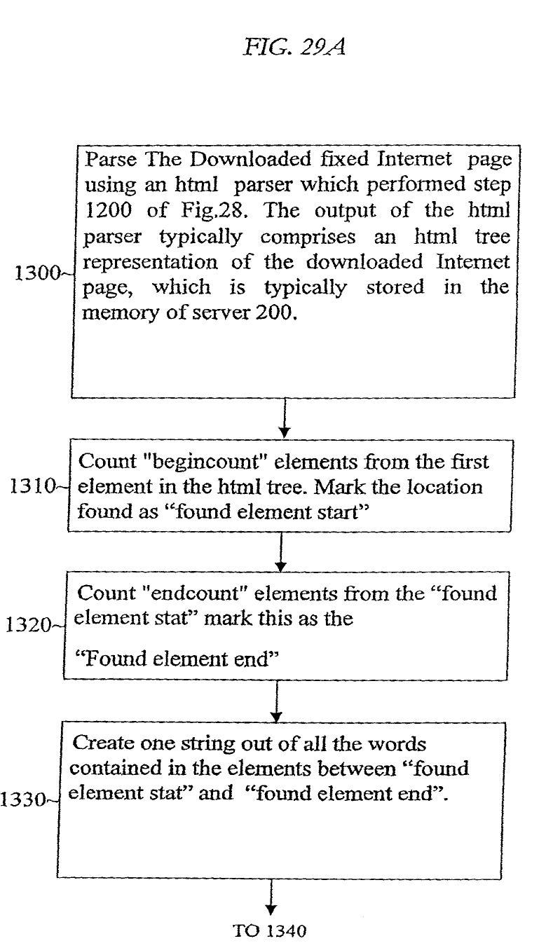

FIGS. 28A-28C, taken together, form a simplified flowchart illustration of a preferred method for performing step 480 of FIG. 7G. As shown in FIG. 7G, in step 480, the personal consolidation server software 200 of FIG. 1 is operative to analyze a user-selected and -marked fixed Internet page, also termed herein a “marked page”, for content pertaining to a selection area defined by the user. The output of step 480 is item extraction information which is stored in the item table of FIG. 6D and used, in step 550 of FIG. 8B by personal consolidation server software 200 of FIG. 1, to extract information and display it on a mobile communicator device.

The term “html element” is used herein to refer to any entity from among the entities that a particular parser is capable of identifying. Typically, the output of a parser comprises a hierarchy defining relationship between such entities and unidentified text portions i.e. text portions that has not been identified as any of the elements which the parser recognizes.

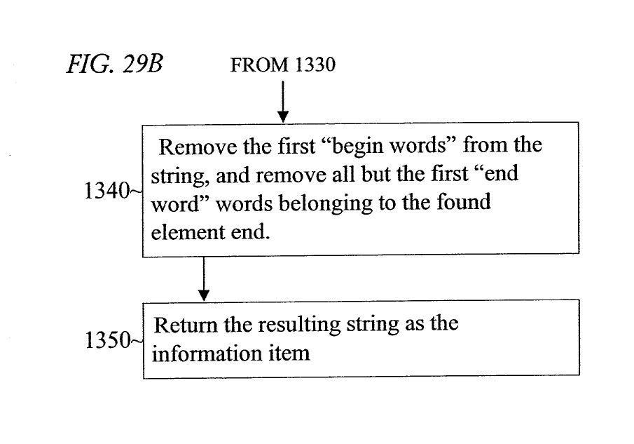

FIGS. 29A-29B, taken together, form a simplified flowchart illustration of a preferred method for performing step 550 of FIG. 8B. As described above, in step 550, the item extraction information generated by the method of FIG. 28 is used to extract a portion of a downloaded fixed internet page.

The embodiments of FIGS. 28A-29B assume that the Internet pages from which the user culls his information items seldom change. If the pages from which the user culls his information items do change, the user simply remarks the desired information item on those pages.

Reference is now made to CD-ROM Appendix A which includes software object code for carrying out a preferred embodiment of the invention. This code may be installed as follows:

I. Provide a computer terminal, such as an Intel-based Pentium III 800 MHz computer, 256 MB RAM, 6 GB Hard Disk and Network Adapter configured with Microsoft Windows 2000 Advanced Server 5.00.2195 (Service Pack 1) operating system.

II. Install Microsoft Internet Information Services 5.0 including World Wide Web Server and SMTP Server.

III. Install Microsoft SQL 2000 Server and Client Tools.

IV. Copy the file MPREST.HEX in the \apndx-A folder stored in the appended CD-ROM into a temporary directory.

V. Unhex the computer listing MPREST.HEX mentioned in step IV using HEX IT V1.8 or greater by John Augustine, 3129 Earl St., Laureldale, Pa 19605 creating file MPREST_SETUP.EXE

VI. Execute the file MPREST_SETUP.EXE extracting all files into their respective directories.

VII. In directory C:\mPrest\CONFIG edit WAPDWAP.REG, GLOBALCONFIG.REG, REGISTRATION.REG and REGGLOBALS.ASP files and set all server names to “LOCALHOST”.

VIII. Register required data by double clicking on ALGORITHM.REG, GLOBALCONFIG.REG, WAPDWAP.REG and REGISTRATION.REG files.

IX. Add the following path to Environment System Variables: C:\mPrest\LIBRARIES; C:\mPrest\CS; C:\mPrest\PS.

X. Using Computer Management add the following Local users: IUSR_WDW (Guest Account) and IWAM_WDW (Administrator Account).

XI. Open Local Security Settings−>Local Policies −>User Rights Assignment−>“Act as a part of the operating system” and add IWAM_WDW user.

XII. Open Internet Services Manager Console.

XIII. Open the Default Web Site Properties and make the following changes:

A. Under Home Directory Tab change Local Path to C:\mPrest\CS.

B. Under Home Directory Tab set Execute Permissions to “Scripts and Executables”.

C. Under Home Directory Tab set Application Protection to be High (Isolated).

D. Under Documents Tab check “Enable Default Document” checkbox and add CS.DLL deleting the default ones.

E. Under ISAPI Filters Tab add new filter from C:\mPrest\CS\WDW_FILTERSMS.DLL

F. Under Directory Security Tab edit “Anonymous access and authentication control” settings, then “Anonymous access” and enter IUSR_WDW as Username and Password.

XIV. Create New Virtual Directory under Default Web Site using “PS” as Alias and C:\mPrest\PS\as Home Directory with Execute (such as ISAPI applications or CGI) Access Permissions only.

XV. Open “PS” Virtual Directory Properties and under “Virtual Directory” Tab set “Application Protection” to be High (Isolated).

XVI. Create New Virtual Directory under Default Web Site using “REGISTRATION” as Alias and C:\mPrest\REGISTRATION\as Home Directory with Read and Execute (such as ISAPI applications or CGI) Access Permissions only.

XVII. Open Component Services Console and go to Component Services−>Computers−>My Computer−>COM+Applications−>IIS-{Default Web Site//Root}.

XVIII. Open IIS-{Default Web Site//Root} Properties and under Identity Tab enter IWAM WDW as User and Password.

XIX. Using SQL 2000 Query Analyzer load and execute the following scripts from C:\mPrest\DB: WapDwapData.sql, LogsData.sql, History.sql and MoreData.sql.

XX. Restart the computer.

The software embodiment of Appendix A can be run as follows:

I. Start users registration by opening the Internet Explorer and going to the following URL: http://localhost/registration/registration.asp

II. Follow the registration instructions, register and download the mPrest Plugin.

III. Once mPrest Plugin has been installed, press the Help button, and follow the on-line help to operate the plug-in.

It is appreciated that the software components of the present invention may, if desired, be implemented in ROM (read-only memory) form. The software components may, generally, be implemented in hardware, if desired, using conventional techniques.

It is appreciated that the particular embodiment described in the Appendices is intended only to provide an extremely detailed disclosure of the present invention and is not intended to be limiting.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited to what has been particularly shown and described hereinabove. Rather, the scope of the present invention is defined only by the claims that follow:

1. A methodology for providing content to a user via a mobile communicator having limited display capabilities, the methodology comprising:
enabling a user to access a web site via a device other than said mobile communicator;
enabling a user to view content on said web site; and
enabling a user to select content of interest to the user forming at least part of said content, wherein a user selection takes place while the user views at least part of said content of interest.

2. A methodology according to claim 1 and wherein said user selection takes place while the user views at least part of said content of interest in the format that it normally appears on said web site.

3. A methodology according to claim 1 and wherein said user selection may be effected by at least one mouse click on at least a portion of said content of interest.

4. A methodology according to claim 1 and wherein said user selection may be effected by at least one mouse click on an icon located adjacent at least a portion of said content of interest.

5. A methodology according to claim 1 and wherein said user selection may be effected by dragging and dropping at least a portion of said content of interest.

6. A methodology according to claim 1 and wherein said user selection may be effected by dragging and dropping an icon located adjacent at least a portion of said content of interest.

7. A methodology according to claim 2 and wherein said user selection may be effected by at least one mouse click on at least a portion of said content of interest.

8. A methodology according to claim 2 and wherein said user selection may be effected by at least one mouse click on an icon located adjacent at least a portion of said content of interest.

9. A methodology according to claim 2 and wherein said user selection may be effected by dragging and dropping at least a portion of said content of interest.

10. A methodology according to claim 2 and wherein said user selection may be effected by dragging and dropping an icon located adjacent at least a portion of said content of interest.

11. A methodology according to claim 1 and wherein:
said user selection includes user select ion of multiple items of interest to be provided for display on said mobile communicator; and
said mobile communicator is operative for displaying at least a plurality of said multiple items of interest for simultaneous viewing thereon.

12. A methodology according to claim 11 and wherein said multiple items of interest originate from multiple web sites.

13. A methodology according to claim 12 and wherein said multiple web sites are not necessarily linked.

14. A methodology according to claim 1 and also comprising:
automatically providing a link from said content of interest to mobile communicator-configured content; and
displaying at least said mobile communicator-configured content on said mobile communicator.

15. A methodology according to claim 14 and wherein said mobile communicator-configured content includes at least part of said content of interest selected by said user.

16. A methodology according to claim 14 and wherein said mobile communicator-configured content includes at least part of said content of interest selected by said user and also includes other content related thereto.

17. A methodology according to claim 14 and wherein said mobile communicator-configured content includes at least part of said content of interest selected by said user as well as other content related thereto which was not viewed by the user on, said device other than said mobile communicator.

18. A methodology according to claim 1 and comprising:
enabling said user to select said content of interest to the user on said at least one web site for display to the user on said mobile communicator in the form of at least one page appearing in a mobile communicator-configured format; and
in response to a user request to receive said at least one page, downloading at least part of said content of interest from said at least one web site generally in real time.

19. A methodology according to claim 18 and wherein said at least one page comprises a single page.

20. A methodology according to claim 18 and also comprising:
automatically updating said at least one page to include therein content of interest which was not available generally in real time.

21. A methodology for providing content to a user via a mobile communicator having limited display capabilities, the methodology comprising:
enabling a user to access at least one web site via a device other than said mobile communicator;
enabling a user to select multiple items of interest to be provided for display on said mobile communicator; and
displaying at least a plurality of said multiple items of interest for simultaneous viewing on said mobile communicator.

22. A methodology according to claim 21 and wherein said multiple items of interest originate from multiple web sites.

23. A methodology according to claim 22 and wherein said multiple web sites are not necessarily linked.

24. A methodology according to claim 21 and also comprising:
automatically providing a link from at least one of said multiple items of interest to mobile communicator-configured content; and
displaying at least said mobile communicator-configured content on said mobile communicator.

25. A methodology according to claim 24 and wherein said mobile communicator-configured content includes at least part of said at least one of said multiple items of interest selected by said user.

26. A methodology according to claim 14 and wherein said mobile communicator-configured content includes at least part of said at least one of said multiple items of interest selected by said user and also includes other content related thereto.

27. A methodology according to claim 14 and wherein said mobile communicator-configured content includes at least part of said at least one of said multiple items of interest selected by said user as well as other content related thereto which was not viewed by the user on said device other than said mobile communicator.

28. A methodology according to claim 21 and comprising:
enabling said user to select said content of interest to the user on said at least one web site for display to the user on said mobile communicator in the form of at least one page appearing in a mobile communicator-configured format; and
in response to a user request to receive said at least one page, downloading at least part of said content of interest from said at least one web site generally in real time.

29. A methodology according to claim 28 and wherein said at least one page comprises a single page.

30. A methodology according to claim 28 and also comprising:
automatically updating said at least one page to include therein content of interest which was not available generally in real time.

31. A methodology for providing content to a user via a mobile communicator having limited display capabilities, the methodology comprising:
enabling a user to select content of interest at least one web site via a device other than said mobile communicator;
automatically providing a link from said content of interest to mobile communicator-configured content; and
displaying at least said mobile communicator-configured content on said mobile communicator.

32. A methodology according to claim 31 and wherein said mobile communicator-configured content includes at least part of said content of interest selected by said user.

33. A methodology according to claim 31 and wherein said mobile communicator-configured content includes at least part of said content of interest selected by said user and also includes other content related thereto.

34. A methodology according to claim 33 and wherein said mobile communicator-configured content includes at least part of said content of interest selected by said user as well as other content related thereto which was not viewed by the user on said device other than said mobile communicator.

35. A methodology according to claim 31 and comprising:
enabling said user to select said content of interest to the user on said at least one web site for display to the user on said mobile communicator in the form of at least one page appearing in a mobile communicator-configured format; and
in response to a user request to receive said at least one page, downloading at least part of said content of interest from said at least one web site generally in real time.

36. A methodology according to claim 35 and wherein said at least one page comprises a single page.

37. A methodology according to claim 35 and also comprising:
automatically updating said at least one page to include therein content of interest which was not available generally in real time.

38. A methodology for providing content to a user via a mobile communicator having limited display capabilities, the methodology comprising:
enabling a user to select content of interest to the user on at least one web site for display to the user on said mobile communicator in the form of at least one page appearing in a mobile communicator-configured format; and
in response to a user request to receive said at least one page, downloading at least part of said content of interest from said at least one web site generally in real time.

39. A methodology according to claim 38 and wherein said at least one page comprises a single page.

40. A methodology according to claim 38 and also comprising:
automatically updating said at least one page to include therein content of interest which was not available generally in real time.

41. A methodology for providing content to a user via a mobile communicator having limited display capabilities, the methodology comprising enabling a user to select content of interest to the user on a mark up language rendered page viewable to the user, wherein the user is enabled to specify selected content to a resolution finer than that defined by tags of said mark up language.

42. A methodology according to claim 41 and wherein said user is enabled to select said content of interest when viewing said mark up language rendered page on a screen of a mobile communicator.

43. A methodology according to claim 41 and wherein said user is enabled to select said content of interest when viewing said mark up language rendered page other than on a screen of a mobile communicator.

44. A methodology for providing content to a user via a mobile communicator having limited display capabilities, the methodology comprising enabling a user to select content of interest to the user on a mark up language rendered page viewable to the user, wherein the user is enabled to specify selected content to a user selected resolution and the content specifically selectable by the user to a user selected resolution includes:
at least some content which is designated by tags to at least said user-selected resolution; and
at least some content which is designated by tags to a resolution coarser than said user-selected resolution.

45. A methodology for providing content to a user via a mobile communicator having limited display capabilities, the methodology comprising:
providing at least one user interface server;
receiving and storing at least one user preference at said at least one user interface server;
collecting information from a plurality of web servers at least partially in accordance with said at least one user preference; and
supplying at least part of said information to said at least one mobile communicator.

46. A methodology according to claim 45 and wherein said at least one user preference is received from a computer rather than from a mobile communicator.

47. A methodology according to claim 45 and wherein said at least one user preference is received from a mobile communicator.

48. A methodology according to claim 45 and also comprising: receiving, at said at least one user interface server, at least one request from at least one mobile communicator; and wherein:
said at least one user interface server is operative for collecting said information responsive to said at least one request.

49. A methodology according to claim 48 and wherein said at least one user preference is received by said at least one user interface server at a time substantially earlier than the time at which said at least one user interface server receives said at least one request and supplies said at lest part of said information to said at least one mobile communicator.

50. A methodology according to claim 46 and wherein said computer provides personal user preferences of multiple users.

51. A methodology for providing content to a user via a mobile communicator having limited display capabilities, the methodology comprising enabling a user to select content of interest to the user on a mark up language rendered page viewable to the user, wherein at least in certain instances when the user selects said content of interest, mobile communicator specific data linked to said content of interest is made available for use by said mobile communicator.

52. A methodology according to claim 51 and wherein said data includes at least one of:
an address of at least one mobile communicator formatted page;
a function that enables retrieval of information from a web server; and
at least part of information required for executing a commercial transaction.

53. A methodology according to claim 52 and wherein said at least part of information required for executing a commercial transaction includes a function that enables retrieval of client information by said web server.

54. A methodology according to claim 51 and wherein said data includes at least one of:
an address of at least one mobile communicator formatted page;
a function that enables retrieval of information from a web server; and
at some client information.

55. A methodology for providing dynamically changing information to a user comprising:
selecting by a user of dynamic content of interest while the user views said content of interest on a dynamically changing web site;
in response to said user selecting said dynamic content of interest, automatically analyzing the context of said content of interest on said web site; and
thereafter automatically providing to said user substantially only said content of interest which was selected by said user, notwithstanding dynamic changes in the said content of interest and notwithstanding at least some changes in said context in said dynamically changing website.

56. A system for providing content to a user via a mobile communicator having limited display capabilities, the system comprising enabling a user to select content of interest to the user on a mark up language rendered page viewable to the user, wherein at least in certain instances when the user selects said content of interest, mobile communicator specific data linked to said content of interest is made available for use by said mobile communicator.

57. A system for providing content to a user via a mobile communicator having limited display capabilities, the system comprising:
at least one user interface server receiving and storing at least one user preference;
an information collector operative to collect information from a plurality of web servers at least partially in accordance with said at least one user preference; and
an information communicator supplying at least part of said information to said at least one mobile communicator.

58. A system for providing dynamically changing information to a user comprising:
a content selector operative to receive from a user a selection of dynamic content of interest while displaying said content of interest to the user on a dynamically changing web site;
a context analyzer operative, in response to said user selecting said dynamic content of interest, to automatically analyze the context of said content of interest on said web site; and
a content provider operative, thereafter, to automatically provide to said user substantially only said content of interest which was selected by said user, notwithstanding dynamic changes in the said content of interest and notwithstanding at least some changes in said context in said dynamically changing website.

59. A method for providing content to a user via a mobile communicator having limited display capabilities, the method comprising:
enabling a user to select content of interest to the user on a page viewable to the user, the page being represented digitally in a format having a unit of representation,
wherein the user is enabled to specify selected content to a resolution finer than that defined by said units of representation.

60. A method according claim 71 wherein said unit of representation comprises an html tag and said content having finer resolution comprises one of the following group of content types:
content at the sub-tag level;
content at the sub-table level;
content at the sub-cell level.

61. A methodology for providing content to a user via a communicator having limited display capabilities, the methodology comprising:
enabling a user to access a web site via a device other than said communicator, said device having display capabilities which exceed those of said communicator;
enabling a user to view content on said web site; and
enabling a user to select content of interest to the user forming at least part of said content, wherein a user selection takes place while the user views at least part of said content of interest.

62. A system for providing content to a user via a mobile communicator having limited display capabilities, the system comprising:
a website access device enabling a user to access a web site via a device other than the mobile communicator;
a content viewing GUI enabling a user to view content on said web site and to select content of interest to the user forming at least part of said content, wherein the GUI is operative to receive a user selection while displaying at least part of said content of interest to the user.

63. A system for providing content to a user via a mobile communicator having limited display capabilities, the system comprising:
a website access device enabling a user to access a web site via a device other than the mobile communicator;
a selector enabling the user to select multiple items of interest to be provided for display on said mobile communicator; and
a simultaneous viewer operative to display at least a plurality of said multiple items of interest for simultaneous viewing on said mobile communicator.

64. A system for providing content to a user via a mobile communicator having limited display capabilities, the system comprising:
a website content selection device enabling a user to select content of interest at at least one web site via a device other than the mobile communicator;
a link provider automatically providing a link from said content of interest to mobile communicator-configured content; and
a content display generator operative to display at least said mobile communicator-configured content on said mobile communicator.

65. A system for providing content to a user via a mobile communicator having limited display capabilities, the system comprising:
a content selector enabling a user to select content of interest to the user on at least one web site for display to the user on said mobile communicator in the form of at least one page appearing in a mobile communicator-configured format; and
a real time content downloader operative in response to a user request to receive said at least one page, to download at least part of said content of interest from said at least one web site generally in real time.

66. A system for providing content to a user via a mobile communicator having limited display capabilities, the system comprising a content selector enabling a user to select content of interest to the user on a mark up language rendered page viewable to the user, wherein the user is enabled to specify selected content to a resolution finer than that defined by tags of said mark up language.

67. A system for providing content to a user via a mobile communicator having limited display capabilities, the system comprising a content selector operative to enable a user to select content of interest to the user on a mark up language rendered page viewable to the user, wherein the user is enabled to specify selected content to a user selected resolution;
and wherein the content specifically selectable by the user to a user selected resolution includes:
at least some content which is designated by tags to at least said user-selected resolution; and
at least some content which is designated by tags to a resolution coarser than said user-selected resolution.
